(19) United States
(12) Patent Application Publication
(10) Pub. No.: US 2024/0134666 A1
(43) Pub. Date: Apr. 25, 2024

(54) HYBRID JUST IN TIME LOAD MODULE COMPILER WITH PERFORMANCE OPTIMIZATIONS

(71) Applicant: LZLABS GMBH, Wallisellen (CH)

(72) Inventors: Jan Jaeger, Wallisellen (CH); Pietro Fezzardi, Wallisellen (CH); Alessandro Di Federico, Wallisellen (CH)

(21) Appl. No.: 18/548,067

(22) PCT Filed: Feb. 25, 2022
(86) PCT No.: PCT/IB2022/051686

§ 371 Date: Aug. 24, 2023

Related U.S. Application Data
(60) Provisional application No. 63/154,333, filed on Feb. 26, 2021.

(51) Int. Cl. G06F 9/455

(52) U.S. Cl. CPC G06F 9/4552

(57) ABSTRACT

The disclosure provides methods for generating libraries of transformation functions and for executing programs compiled for a source architecture on machines having a different target architecture using a hybrid just-in-time load module compiler, a non-transitory computer-readable medium to store instructions for performing such methods, and systems for performing such methods. The systems and methods may enable effective operation of the load module compiler with self-modifying code, and may apply optimizations in the selections of basic blocks for just-in-time compilation, and in the use of optimized library functions to improve system performance.

### CROSS REFERENCE TO RELATED APPLICATIONS

This application claims the benefit of priority of U.S. Provisional Patent Application No. 63/154,333, filed Feb. 26, 2021, titled HYBRID JUST IN TIME LOAD MODULE COMPILER, which is hereby incorporated by reference herein in its entirety.

### TECHNICAL FIELD

The present invention relates to techniques and systems for executing a program compiled for a source architecture on a machine having a different target architecture.

### BACKGROUND

A compiler, such as a Cobol compiler, translates a source code program made up of one or more source code files into object code including one or more processor language program files. These object code files, in some cases together with additional object files, can be linked and assembled into an executable program. Such an executable program is constrained to run only on a processor of a specific architecture and instruction set. Typically, a processor of a given architecture has associated with its architecture an instruction set. Processors having different architectures support different instruction sets, with the result that an executable program including processor instructions of one instruction set will not generally execute on a processor having a different architecture and different corresponding instruction set.

Just in time compilation, JIT, or dynamic translation, is compilation that occurs at runtime—during the execution of a program. Because the compilation happens at runtime, a JIT compiler can use dynamic runtime information to perform optimizations. Dynamic runtime parameters are not available to the static compiler, but they may be used by a JIT compiler to identify optimization opportunities, such as the in-lining of functions.

A typical compiler tokenizes and parses source code, constructs an abstract syntax tree to represent the code in an intermediate representation, may contain one or more optimization stages, and then uses a code generator to translate the optimized intermediate representation into executable code in the instruction set of the target architecture. LLVM is an open-source compiler framework that includes a just-in-time compiler, the ORC JIT, that can be used to compile source programs to executable code at runtime. The LLVM framework facilitates the development of retargetable compilers, which can employ different compiler backend, by employing a common intermediate representation. The intermediate representation of LLVM, LLVM IR, operates as a common abstraction layer, enabling backend compiler developers to implement target-specific functions and optimizations. A description of LLVM can be found in chapter 11 of “The Architecture of Open Source Applications, Elegance, Evolution, and a Few Fearless Hacks,” Brown, Amy and Wilson, Greg, eds., which explains the structure and evolution of the LLVM project.

A load module refers to all or part of an executable program, typically in the context of a legacy, mainframe computing environment. A compiler and linker may be used to translate a legacy source code programs, such Cobol programs or database applications, into an executable load modules that can run on a System 370, 390 ZOS mainframe. For a variety of reasons, recompiling the original legacy source program to run on a different target architecture is often undesired. Some examples include difficulty accurately identifying all of the required source code, difficulties that may arise if the source code is compiled with different settings, or in an environment that may inadvertently include different components, due to difficulties in performing functional or integration testing to ensure that the recompiled code will perform in the same manner as the original program, or the difficulty disentangling code from numerous, and often unknown dependencies. In other examples, source code may no longer be available, or a previous compiler or version of the compiler used with the original source code may no longer be available.

One approach to retargeting applications from an architecture running one hardware instruction set to an architecture running a different hardware instruction set is emulation. In a conventional emulation system, for each instruction or set of instructions that would ordinarily execute on the first architecture, the emulation system must perform appropriate translations, thereby simulating the operation of the emulated environment. Some emulation systems host a guest operating system in an emulator, and then run programs in a software layer atop the emulated execution of the guest operating system. This emulation approach may suffer from reduced performance due to multiple layers of translation required to execute the software. Other emulation systems emulate both the hardware and operating system functions of a first architecture, to allow applications written to run on the first architecture to operate in an emulated runtime environment. While this approach can reduce the number of layers in the emulation stack, it may also suffer from poor performance due to the overhead of emulating system or library calls, or other complex system functions. In addition to emulating the instructions, an emulator may also support memory management and system data structures, to ensure interoperability with programs running in a legacy environment. Performance of the emulator can be improved by optimizing the emulator's implementation of individual legacy hardware and software instructions. However, even an optimized emulator will typically not perform as well as a similarly optimized native application.

A load module compiler that can receive as input a compiled legacy load module such as a Cobol load module compiled for a System 390 mainframe and generate as output an executable program that could run on a 64 bit x86 architecture while continuing to make external references accessible would enable the migration of mainframe computing jobs to a non-mainframe environment without rewriting and/or recompiling the original Cobol source code. However, compilers that retarget executable code configured to execute in accordance with a first instruction set and environment into executable code configured to execute in accordance with a second instruction set and environment can be closely coupled to both the first and the second instruction sets.

Translating code from a first computer architecture to another typically introduces changes that break interfaces between previously interoperable programs. For example, in the case of call back programs that pass as parameters the addresses of routines or functions to allow a receiving program to invoke a routine in a calling program, translation through decompilation and recompilation to a different target architecture will typically change the addresses, and may change the size of address operands, so as to disrupt the ability of the receiving program to invoke the remote routine. Parsing, rather than decompilation of the received program may enable program translation, but the challenges of address and operand translation are still present.

One previous load module compiler operated by transcompiling load modules from executable legacy code to x86 code, by translating individual functions in C-program macro calls, and compiling each such function into x86 code that was subsequently linked and executable. Where an interpreter executed between 200 and 300 instructions in emulation for each native legacy instruction, the load module compiler generated executables corresponding to a given instruction that used far fewer instructions, resulting in considerable performance gains. Methods for enabling the transcompilation of executable programs, that translate the mappings required to correctly invoke external references have been discussed in U.S. Pat. No. 10,713,024 titled Load Module Compiler, which is incorporated by reference herein in its entirety. However, the need for a priori compilation by the load module compiler limited its flexibility.

A just-in-time load module compiler increased flexibility, but required recompilation each time a load module was run, and could not be used in cases of self-modifying programs.

Some executable programs are self-modifying, either for reasons of performance or interoperability with other programs. Such self-modifying programs blur the distinction between program data and program instructions, and are difficult to parse or to compile using just-in-time compilation techniques. The possibility that one such self-modifying programs may be present in a set of load modules presents an obstacle to just-in-time compilation. Whether or not a program modifies its own instructions may not be known until runtime, which can further complicate the identification of code that is suitable for execution in a load module compiler. In many applications, some program code is seldom, if ever executed. Just-in-time compiling code that is not executed, or is only rarely executed, is inefficient and reduces overall system performance. It would be desirable for a load module compiler to support self-modifying application code, to avoid the need to select only programs that are known not to be self-modifying for use with a load module compiler.

In order to take advantage of the performance benefits of a load module compiler, while ensuring that programs that are unsuitable for JIT compilation can still be executed on the alternate architecture, a load module compiler can be configured to share an operating environment with an emulation system. An example of such a hybrid environment is described in U.S. Pat. No. 9,779,034 titled Protection Key Management and Prefixing in Virtual Address Space Emulation System, which is incorporated herein by reference in its entirety. A load module compiler described in that environment included a decompiler that translated each legacy instruction of a Cobol load module into a macro in accordance with the rules of the C programming language. This intermediate representation of legacy instructions could then be processed by the back-end compiler of the load module compiler, to produce X86 instructions. Because the compiler implements the behavior of each legacy instruction individually, opportunities for optimization across sets of instructions are missed.

In addition, where the intermediate representation of load module compiler is proprietary, care must be taken to ensure that the state of the system, when running code generated by the load module compiler, will be consistent with the state of the system when running the corresponding code in emulation. In addition, the use of a proprietary intermediate representation format limits some optimizations that might be performed by the load module compiler, and increases the compiler development work that must be done to retarget load modules toward a different version of the x86 architecture, the ARM architecture, or to another architecture, since each retargeting requires the custom development of back-end compiler code for translating the proprietary intermediate representation into native instructions.

### SUMMARY

The present disclosure provides method for constructing a library of transformation functions for translating legacy programs from a source architecture to a target architecture, the method including: providing a first library of transformation functions that each transform a statement in a legacy executable program into a representation in an intermediate representation; receiving a load module; obtaining an original legacy instruction or legacy system call from the load module in a first system architecture; obtaining a function from said legacy function library, the function being in an intermediate representation of code for implementing the legacy function; inserting said function obtained from said library for said original legacy instruction or legacy system call into an intermediate representation of a basic block; inserting labels corresponding to said function into an index associated with said basic block; and storing said intermediate representation of said basic block and said index into a second library of transformation functions, wherein each transformation function of said second library represents a basic block encoded in an intermediate representation.

The method may further include any of the following additional steps or embodiments, which may all be combined with one another in any combinations unless clearly mutually exclusive: further including parsing a sequence of instructions or function calls of said load module by a parser; wherein said parsing includes identifying each instruction or function call in a basic block of said load module; wherein said basic block includes a sequence of instructions beginning with an entry point and continuing to a branch instruction; wherein said basic block includes a sequence of instructions beginning with an entry point and continuing to an instruction that branches to an address not already identified within the basic block; wherein said basic block includes a sequence of instructions beginning with an entry point, and continuing to the earlier of a branch instruction, or until a predefined threshold number of instructions is included in the basic block; or wherein the instructions of said basic block include a sequence of instructions beginning with an entry point, and continuing until a state saving operation is detected within a CSECT of the legacy executable program is detected.

The present disclosure further provides a non-transitory computer readable medium configured to store instructions, the instructions when executed by one or more processors to cause the one or more processors to execute a first legacy executable program compiled for a first architecture on a machine having a target architecture different from the source architecture by performing steps including: providing a first library of transformation functions that each transform a statement in said legacy executable program into a representation in an intermediate representation; receiving a load module; obtaining an original legacy instruction or legacy system call from the load module in a said first system architecture; obtaining a function from said legacy function library, the function being in an intermediate representation of code for implementing the legacy function; inserting said function obtained from said library for said original legacy instruction or legacy system call into an intermediate representation of a basic block; inserting labels corresponding to said function into an index associated with said basic block; and storing said intermediate representation of said basic block and said index into a second library of transformation functions, wherein each transformation function of said second library represents a basic block encoded in an intermediate representation.

The non-transitory computer readable medium may further include any of the following components, steps, or embodiments, which may all be combined with one another in any combinations unless clearly mutually exclusive: further including parsing a sequence of instructions or function calls of said load module by a parser, to identify each instruction or function call in a basic block; or wherein said basic block includes a sequence of instructions beginning with an entry point, and continuing to the earlier of a branch instruction whose target lies outside the basic block, or until a predefined threshold number of instructions is included in the basic block.

The present disclosure further provides a method of generating a library of intermediate representations of basic blocks of a first program, compiled for a source architecture having an instruction set that differs from the instruction set of a target architecture, for use by a load module compiler, the method including: providing a first library of legacy functions that each transform one or more instructions of said source architecture into an intermediate representation; generating by a decompiler, an indicator of the compiler type used to compile said first program according to said source architecture using metadata associated with said first program; based on said indicator, identifying by the decompiler, a set of instructions to initialize the first program; replacing said set of instructions with an intermediate representation of an initialization routine; parsing said first program by said decompiler, to identify sequences of instructions and system calls corresponding to a basic block of said first program; replacing said sequences of instructions and system calls, by in-lining functions from said first library into an object corresponding to said basic block; and storing the intermediate representation of said basic block in a second library.

The method may further include repeating the steps of parsing and replacing said sets of sequences for each basic block of the first program to be compiled by the load module compiler.

The present disclosure further provides a non-transitory computer readable medium configured to store instructions, the instructions when executed by one or more processors to cause the one or more processors to generate a library of intermediate representations of basic blocks of a first program compiled for a source architecture having an instruction set that differs from the instruction set of a target architecture, for use by a load module compiler, the generating of the library including: providing a first library of legacy functions that each transform one or more instructions of said source architecture into an intermediate representation; generating by a decompiler, an indicator of the compiler type used to compile said first program according to said source architecture using metadata associated with said first program; based on said indicator, identifying by the decompiler, a set of instructions to initialize the first program; replacing said set of instructions with an intermediate representation of an initialization routine; parsing said first program by said decompiler, to identify a sequence of instructions and system calls corresponding to a basic block of said first program; replacing said sequences of instructions and system calls, by in-lining functions from said first library into an object corresponding to said basic block; and storing the intermediate representation of said basic block in a second library.

The non-transitory computer readable medium may further include any of the following components, steps, or embodiments, which may all be combined with one another in any combinations unless clearly mutually exclusive: wherein said generating further includes repeating the steps of parsing and replacing said sets of sequences for each basic block of the first program to be compiled by the load module compiler; wherein said identifying a sequence of instructions by the decompiler includes selecting a sequence of instructions using a predefined parameter that specifies a maximum number of instructions permitted in a basic block; wherein said identifying a sequence of instructions by the decompiler includes identifying a branch to an instruction whose address lies outside the range of instructions determined to lie within the basic block; wherein said identifying a sequence of instructions by the decompiler further includes identifying a state saving operation within the specified maximum number of instructions, and ending the basic block at the state saving instruction; or wherein said identifying a state saving operation includes a memory write operation.

The present disclosure further provides a method of executing a first program compiled for a source architecture on a processor having a target architecture different from the source architecture, the method including: providing a library of legacy functions that each transform one or more instructions of said source architecture into an intermediate representation; parsing said first program to identify a sequence of instructions of said source architecture including a basic block; replacing the instructions with functions of said library, to generate an intermediate representation of said basic block; storing the intermediate representation of said basic block in a store; compiling by a back-end compiler, said intermediate representation of said basic block, into a representation of said basic block in said target architecture; storing said compiled representation of said basic block in a cache indexed by processor type; retrieving said compiled representation of said basic block from said cache; and linking said basic block in a runtime environment, said runtime environment configured for execution of instructions in accordance with said target architecture.

The method may further include any of the following additional steps or embodiments, which may all be combined with one another in any combinations unless clearly mutually exclusive: wherein said legacy functions of said library of legacy functions include functions of an interpreter, compiled into an intermediate representation; wherein said intermediate representation includes an LLVM-IR representation; wherein said legacy functions of said library of legacy functions further include one or more initialization functions; further including obtaining from metadata associated with said first program, an indication of the compiler type used to compile said first program into executable form according to said source architecture; further including using an indicator of the compiler type used to compile the first program into executable form according to said source architecture, to enable optimization by a decompiler; wherein said decompiler replaces a plurality of instructions of said next basic block in accordance with said source architecture, with an intermediate representation of an initialization routine in said intermediate representation of said basic block, based upon said indicator; wherein said decompiler replaces a plurality of instructions of said next basic block in accordance with said source architecture, with an intermediate representation of an input-output routine in said intermediate representation of said basic block, based upon said indicator; further including compiling by a second back-end compiler, said intermediate representation of said basic block, into a second representation of said basic block said target architecture, and storing said compiled basic block in said cache, with an index entry indicating the processor type associated with said second back-end compiler; further including removing by said back-end compiler an instruction to store a value in memory and a corresponding instruction to retrieve the value from memory from code in in-lined functions of the basic block; further including removing by said back-end compiler instructions to push parameters onto the stack, and pull parameters from the stack, in functions of the basic block; further including substituting the values of constants directly into the code of the basic block; further including removing the back-end compiler of the load module compiler, code that generates return values that are not used by the calling function; further including using the indication of compiler type to enable the replacement a legacy ABI call with a call to an optimized external function; or further including detecting an attempt by the basic block to write to its own program storage area, permitting the write, incrementing an indicator of writes to the program storage area by the basic block, and directing the runtime to execute a non-cached copy of the modified basic block.

The present disclosure further provides a non-transitory computer readable medium configured to store instructions, the instructions when executed by one or more processors to cause the one or more processors to execute a first program compiled for a source architecture on a processor having a target architecture different from the source architecture by performing steps including: providing a library of legacy functions that each transform one or more instructions of said source architecture into an intermediate representation; parsing said first program to identify a sequence of instructions of said source architecture including a basic block; replacing the instructions with functions of said library, to generate an intermediate representation of said basic block; storing the intermediate representation of said basic block in a store; compiling by a back-end compiler, said intermediate representation of said basic block, into a representation of said basic block said target architecture; storing said compiled representation of said basic block in a cache indexed by processor type; retrieving said compiled representation of said basic block from said cache; and linking said basic block in a runtime environment, said runtime environment configured for execution of instructions in accordance with said target architecture.

The non-transitory computer readable medium may further include any of the following components, steps, or embodiments, which may all be combined with one another in any combinations unless clearly mutually exclusive: wherein said legacy functions of said library of legacy functions include functions of an interpreter, compiled into an intermediate representation; wherein said intermediate representation includes an LLVM-IR representation; wherein said legacy functions of said library of legacy functions further include one or more initialization functions; further including obtaining from metadata associated with said first program, an indication of the compiler type used to compile said first program into executable form according to said source architecture; further including using an indicator of the compiler type used to compile the first program into executable form according to said source architecture, to enable optimization by a decompiler; wherein said decompiler replaces a plurality of instructions of said next basic block in accordance with said source architecture, with an intermediate representation of an initialization routine in said intermediate representation of said basic block, based upon said indicator; wherein said decompiler replaces a plurality of instructions of said next basic block in accordance with said source architecture, with an intermediate representation of an input-output routine in said intermediate representation of said basic block, based upon said indicator; further including detecting an attempt by the basic block to write to its own program storage area, permitting the write, incrementing an indicator of writes to the program storage area by the basic block, and directing the runtime to execute a non-cached copy of the modified basic block; further including unrolling the execution of the previous instruction of the basic block before said directing.

The present disclosure provides a method of executing a first program compiled for a source architecture on a processor having a target architecture different from the source architecture, the method including: providing a cache of compiled basic blocks, wherein each said compiled basic block is a representation of a basic block of said first program, translated from said source architecture into said target architecture; determining whether a next basic block for the execution of said program by a runtime environment having said target architecture is present in said cache, and whether said cached basic block includes a label required for execution by said runtime; upon determining that said label is present in said next basic block, linking said basic block in the runtime environment and executing the basic block; upon determining that said next basic block is not present in said cache, or that said next basic block is missing said label, initiating a process by a decompiler to identify the next basic block in said first program, and to translate said basic block into an intermediate representation; compiling the intermediate representation of said basic block into an executable for said target architecture, and storing said compiled basic block in said cache.

The method may further include any of the following additional steps or embodiments, which may all be combined with one another in any combinations unless clearly mutually exclusive: wherein said storing includes storing an object, object ID, and an indicator of said target architecture in said cache; wherein the entries of said cache are indexed by target architecture; wherein the entries of said cache are indexed by said program; wherein the entries of said cache are indexed by an identifier of a CSECT in said program; wherein the entries of said cache are indexed by an identifier of the target architecture, a hash of said program, an identifier of a CSECT in said program, and an instruction address; wherein said next basic block begins with a next instruction of said first program, and continues until a subsequent branch instruction; wherein said next basic block begins with a next instruction of said first program, and continues through subsequent instructions of said first program, until a branch to an address outside the range of addresses of said next instruction and said subsequent instructions; wherein the next basic block begins with a next instruction of said first program, and continues until a predetermined number of branch instructions have been parsed; wherein the next basic block begins with a next instruction of said first program, and continues through a predetermined number of instructions; further including detecting by a memory management unit of said runtime, an attempt by said next basic block, to write to the program storage area; further including permitting said next basic block to write to the program storage area, unrolling the execution of said next basic block, recompiling said next basic block, to incorporate the modified program instruction, and storing the compiled, modified next basic block in memory associated with the runtime; further including determining that the number of modifications the basic block has made to itself is less than a predefined threshold value; further including detecting that an instruction modification flag is not set and directing the dispatch of execution flow to an interpreter; wherein said translating said basic block into an intermediate representation includes in-lining functions from a library of functions that implement instructions and system calls of the first system architecture, wherein said functions in said library are stored in an intermediate representation; wherein said determining that the next basic block is in the cache includes a lookup based on the instruction address and the processor type; wherein said lookup is further based on an identifier associated with the C SECT in which the next basic block resides; further including detecting that a flag has been set indicating that a basic block has modified itself, and linking and executing an in-memory copy of the modified basic block, rather than the cache copy, for the modified basic block; further including detecting an attempt by the basic block to write to its own program storage area, permitting the write, incrementing an indicator of writes to the program storage area by the basic block, and directing the runtime to execute a non-cached copy of the modified basic block; or further including unrolling the execution of the previous instruction of the basic block before said directing.

The present disclosure provides a non-transitory computer readable medium configured to store instructions, the instructions when executed by one or more processors to cause the one or more processors to execute a first program compiled for a source architecture on a processor having a target architecture different from the source architecture by performing steps including:
providing a cache of compiled basic blocks, wherein each said compiled basic block is a representation of a basic block of said first program, translated from said source architecture into said target architecture; determining whether a next basic block for the execution of said program by a runtime environment having said target architecture is present in said cache, and whether said cached basic block includes a label required for execution by said runtime; upon determining that said label is present in said next basic block, linking said basic block in the runtime environment and executing the basic block; upon determining that said next basic block is not present in said cache, or that said next basic block is missing said label, initiating a process by a decompiler to identify the next basic block in said first program, and to translate said basic block into an intermediate representation; compiling the intermediate representation of said basic block into an executable for said target architecture, and storing said compiled basic block in said cache.

The non-transitory computer readable medium may further include any of the following components, steps, or embodiments, which may all be combined with one another in any combinations unless clearly mutually exclusive: wherein said storing includes storing an object, object ID, and an indicator of said target architecture in said cache; wherein the entries of said cache are indexed by target architecture; wherein the entries of said cache are indexed by said program; wherein the entries of said cache are indexed by an identifier of a CSECT in said program; wherein the entries of said cache are indexed by an identifier of the target architecture, a hash of said program, an identifier of a C SECT in said program, and an instruction address; wherein said next basic block begins with a next instruction of said first program, and continues until a subsequent branch instruction; wherein said next basic block begins with a next instruction of said first program, and continues through subsequent instructions of said first program, until a branch to an address outside the range of addresses of said next instruction and said subsequent instructions; wherein the next basic block begins with a next instruction of said first program, and continues until a predetermined number of branch instructions have been parsed; wherein the next basic block begins with a next instruction of said first program, and continues through a predetermined number of instructions; further including detecting by a memory management unit of said runtime, an attempt by said next basic block, to write to the program storage area; further including permitting said next basic block to write to the program storage area, unrolling the execution of said next basic block, recompiling said next basic block, to incorporate the modified program instruction, and storing the compiled, modified next basic block in memory associated with the runtime; further including determining that the number of modifications the basic block has made to itself is less than a predefined threshold value; further including detecting that an instruction modification flag is not set and directing the dispatch of execution flow to an interpreter; wherein said translating said basic block into an intermediate representation includes in-lining functions from a library of functions that implement instructions and system calls of the first system architecture, wherein said functions in said library are stored in an intermediate representation; wherein said determining that the next basic block is in the cache includes a lookup based on the instruction address and the processor type; wherein said lookup is further based on an identifier associated with the C SECT in which the next basic block resides; further including detecting that a flag has been set indicating that a basic block has modified itself, and linking and executing an in-memory copy of the modified basic block, rather than the cache copy, for the modified basic block; or further including detecting an attempt by the basic block to write to its own program storage area, permitting the write, incrementing an indicator of writes to the program storage area by the basic block, and directing the runtime to execute a non-cached copy of the modified basic block; further including unrolling the execution of the previous instruction of the basic block before said directing.

The present disclosure further provides a method of executing a first program compiled for a source architecture on a system with one or more processors having a target architecture different from the source architecture, the method including:
initiating execution of the first program in a runtime environment configured to support the execution of programs compiled for execution in the source architecture, said runtime environment operating on one or more of said processors having said target architecture; after the first program has started execution, linking to the first program a basic block compiled by a load module compiler; detecting an attempt by an instruction of said basic block to write to a memory location in a memory block containing a compiled instruction of said first program; determining whether a data structure that stores indications of the addresses of instructions compiled by the load module compiler and linked to the first program exists; upon determining that the data structure does not exist, creating the data structure and populating it with indications of the locations of the instructions compiled by the load module compiler and linked to the first program; allowing execution of the write instruction to modify contents of said memory block containing a compiled instruction of said first program; determining, based on the contents of the data structure, whether the write instruction modified a program instruction; and upon determining that the write instruction modified an instruction of said first program, incrementing a counter associated with the basic block whose instruction was modified, or upon determining that the write instruction did not modify an instruction of said first program, continuing execution of the first program.

The method may further include any of the following additional steps or embodiments, which may all be combined with one another in any combinations unless clearly mutually exclusive: wherein said detecting an attempt to write to a memory location in a memory block containing a compiled program instruction includes detecting an attempt to write to protected storage; further including unprotecting said memory block containing a compiled program instruction; wherein the data structure is a bit map of the address space of the first program; wherein the linked basic block was copied from a cache of compiled basic blocks and placed in protected storage to designate the memory blocks containing the compiled basic blocks as part of a program storage area; further including recompiling by the load module compiler, the basic block whose program instruction was modified; or further including: after creating said data structure, modifying the memory write routine of the runtime environment to: (a) determine, whether the data structure exists, and (b) upon determining that the data structure exists, to initiate a routine to determine, using the data structure, whether a write is a write to a program instruction in the program storage area; and further including: determining at runtime, whether to invoke memory protection handler code capable of performing said step of determining whether a data structure that stores indications of writes to the program storage area exists.

The present disclosure further provides a non-transitory computer readable medium configured to store instructions, the instructions, when executed by one or more processors to cause the one or more processors to execute a first program compiled for a source architecture on a system with one or more processors having a target architecture different from the source architecture by performing the steps including: initiating execution of the first program in a runtime environment configured to support the execution of programs compiled for execution in the source architecture, said runtime environment operating on one or more of said processors having said target architecture; after the first program has started execution, linking to the first program a basic block compiled by a load module compiler; detecting an attempt by an instruction of said basic block to write to a memory location in a memory block containing a compiled instruction of said first program; determining whether a data structure that stores indications of the addresses of instructions compiled by the load module compiler and linked to the first program exists; upon determining that the data structure does not exist, creating the data structure and populating it with indications of the locations of the instructions compiled by the load module compiler and linked to the first program; allowing execution of the write instruction to modify contents of said memory block containing a compiled instruction of said first program; determining, based on the contents of the data structure, whether the write instruction modified a program instruction; and upon determining that the write instruction modified an instruction of said first program, incrementing a counter associated with the basic block whose instruction was modified, or upon determining that the write instruction did not modify an instruction of said first program, continuing execution of the first program.

The non-transitory computer readable medium may further include any of the following components, steps, or embodiments, which may all be combined with one another in any combinations unless clearly mutually exclusive: wherein said detecting an attempt to write to a memory location in a memory block containing a compiled program instruction includes detecting an attempt to write to protected storage; further including unprotecting said memory block containing a compiled program instruction; wherein the data structure is a bit map of the address space of the first program; wherein the linked basic block was copied from a cache of compiled basic blocks and placed in protected storage to designate the memory blocks containing the compiled basic blocks as part of a program storage area; further including recompiling by the load module compiler, the basic block whose program instruction was modified; further including: after creating said data structure, modifying the memory write routine of the runtime environment to: (a) determine, whether the data structure exists, and (b) upon determining that the data structure exists, to initiate a routine to determine, using the data structure, whether a write is a write to a program instruction in the program storage area; or further including: determining at runtime, whether to invoke memory protection handler code capable of performing said step of determining whether a data structure that stores indications of writes to the program storage area exists.

The present disclosure further provides a method of executing a first program compiled for a source architecture on a processor having a target architecture different from the source architecture, the method including: providing a library of legacy functions in an intermediate representation, wherein the legacy functions implement one or more instructions, language functions, or runtime functions of said source architecture; selecting by a decompiler, a sequence of instructions of said first program compiled for said source architecture, wherein the sequence includes a basic block; identifying sets of one or more instructions in said basic block that correspond to one or more functions of said library; replacing the identified sets of one or more instructions with their corresponding library functions to generate an intermediate representation of said basic block; storing the intermediate representation of said basic block in a store; compiling by a back-end compiler, said intermediate representation of said basic block, into a representation of said basic block compiled for said target architecture; storing said compiled representation of said basic block in a cache; retrieving said compiled representation of said basic block from said cache; and linking said compiled representation of the basic block to the first program while the first program is executing in a runtime environment, wherein the runtime environment is configured to execute of instructions of the first program compiled for the source architecture on a processor of the target architecture.

The method may further include any of the following additional steps or embodiments, which may all be combined with one another in any combinations unless clearly mutually exclusive: wherein the intermediate representation includes an LLVM representation of the legacy functions; wherein said selecting by a decompiler is based in-part upon detection of an optimization setting applied by the compiler that compiled the first program for the source architecture; wherein said selecting by a decompiler is based in-part upon determining a version of the compiler that compiled the first program for the source architecture; wherein the decompiler identifies one or more of said sets by selecting a sequence including an ENC instruction preceded by one or more set up instructions; wherein the decompiler identifies the set up instructions preceding the ENC instruction based in-part on determining the version of the compiler that compiled the first program for the source architecture; wherein the decompiler determines the extent of said sequence including a basic block, based in part on detecting a repeated sequence of instructions whose index variable changes; wherein the decompiler determined the extent of said sequence including a basic block, based in part on detecting a repeated sequence of instructions whose index variable changes, followed by a loop; further including determining, by the decompiler, that the repeated sequence of instructions whose index variable changes is a partially unrolled loop; further including creating a loop in the intermediate representation based upon the partially unrolled loop detected by the decompiler; or wherein said compiling by the back-end compiler unrolls the re-rolled loop.

The present disclosure further provides a non-transitory computer readable medium configured to store instructions, the instructions when executed by one or more processors to cause the one or more processors to execute a first program compiled for a source architecture on a processor having a target architecture different from the source architecture by performing the steps including: providing a library of legacy functions in an intermediate representation, wherein the legacy functions implement one or more instructions, language functions, or runtime functions of said source architecture; selecting by a decompiler, a sequence of instructions of said first program compiled for said source architecture, wherein the sequence includes a basic block; identifying sets of one or more instructions in said basic block that correspond to one or more functions of said library; replacing the identified sets of one or more instructions with their corresponding library functions to generate an intermediate representation of said basic block; storing the intermediate representation of said basic block in a store; compiling by a back-end compiler, said intermediate representation of said basic block, into a representation of said basic block compiled for said target architecture; storing said compiled representation of said basic block in a cache; retrieving said compiled representation of said basic block from said cache; and linking said compiled representation of the basic block to the first program while the first program is executing in a runtime environment, wherein the runtime environment is configured to execute of instructions of the first program compiled for the source architecture on a processor of the target architecture.

The method may further include any of the following additional steps or embodiments, which may all be combined with one another in any combinations unless clearly mutually exclusive: wherein the intermediate representation includes an LLVM representation of the legacy functions; wherein said selecting by a decompiler is based in-part upon detection of an optimization setting applied by the compiler that compiled the first program for the source architecture; wherein said selecting by a decompiler is based in-part upon determining a version of the compiler that compiled the first program for the source architecture; wherein the decompiler identifies one or more of said sets by selecting a sequence including an ENC instruction preceded by one or more set up instructions; wherein the decompiler identifies the set up instructions preceding the ENC instruction based in-part on determining the version of the compiler that compiled the first program for the source architecture; wherein the decompiler determines the extent of said sequence including a basic block, based in part on detecting a repeated sequence of instructions whose index variable changes; wherein the decompiler determined the extent of said sequence including a basic block, based in part on detecting a repeated sequence of instructions whose index variable changes, followed by a loop; further including determining, by the decompiler, that the repeated sequence of instructions whose index variable changes is a partially unrolled loop; further including creating a loop in the intermediate representation based upon the partially unrolled loop detected by the decompiler; wherein said compiling by the back-end compiler unrolls the re-rolled loop.

The present disclosure also provides a method of executing a first program compiled for a source architecture on a system with one or more processors having a target architecture different from the source architecture, the method including: initiating execution of the first program in a runtime environment configured to support the execution of programs compiled for execution in the source architecture, said runtime environment operating on one or more of said processors having said target architecture; after the first program has started execution, linking to the first program a basic block compiled by a load module compiler; detecting an attempt by an instruction of said basic block to write to a memory location in a memory block containing a compiled instruction of said first program; determining whether a data structure that stores indications of the addresses of instructions compiled by the load module compiler and linked to the first program exists; upon determining that the data structure does not exist, creating the data structure and populating it with indications of the locations of the instructions compiled by the load module compiler and linked to the first program; allowing execution of the write instruction to modify contents of said memory block containing a compiled instruction of said first program; based in-part on the contents of the data structure, determining whether the write instruction modified a compiled program instruction of said first program that does not have a corresponding basic block in the cache; and upon determining that the write instruction modified an instruction of said first program that does not have a corresponding basic block in the cache, storing an indication that the first program is self-modifying and an indication of the memory location that has been modified.

The method may further include any of the following additional steps or embodiments, which may all be combined with one another in any combinations unless clearly mutually exclusive: further including selecting by a decompiler, another basic block whose addresses include the address that was modified by said write instruction, and generating an intermediate representation of said another basic block; further including compiling by a back-end compiler, said intermediate representation of said another basic block, into a representation of said basic block compiled for said target architecture; or further including linking the representation of the basic block compiled for said target architecture to the first program, and modifying a data structure containing indications of the locations of the instructions compiled by the load module compiler and linked to the first program.

The present disclosure further provides a non-transitory computer readable medium configured to store instructions, the instructions when executed by one or more processors to cause the one or more processors to execute a first program compiled for a source architecture on a processor having a target architecture different from the source architecture by performing the steps including: initiating execution of the first program in a runtime environment configured to support the execution of programs compiled for execution in the source architecture, said runtime environment operating on one or more of said processors having said target architecture; after the first program has started execution, linking to the first program a basic block compiled by a load module compiler; detecting an attempt by an instruction of said basic block to write to a memory location in a memory block containing a compiled instruction of said first program; determining whether a data structure that stores indications of the addresses of instructions compiled by the load module compiler and linked to the first program exists; upon determining that the data structure does not exist, creating the data structure and populating it with indications of the locations of the instructions compiled by the load module compiler and linked to the first program; allowing execution of the write instruction to modify contents of said memory block containing a compiled instruction of said first program; based in-part on the contents of the data structure, determining whether the write instruction modified a compiled program instruction of said first program that does not have a corresponding basic block in the cache; and upon determining that the write instruction modified an instruction of said first program that does not have a corresponding basic block in the cache, storing an indication that the first program is self-modifying and an indication of the memory location that has been modified.

The non-transitory computer readable medium may further include any of the following components, steps, or embodiments, which may all be combined with one another in any combinations unless clearly mutually exclusive: further including selecting by a decompiler, another basic block whose addresses include the address that was modified by said write instruction, and generating an intermediate representation of said another basic block; further including compiling by a back-end compiler, said intermediate representation of said another basic block, into a representation of said basic block compiled for said target architecture; or further including linking the representation of the basic block compiled for said target architecture to the first program, and modifying a data structure containing indications of the locations of the instructions compiled by the load module compiler and linked to the first program.

Although the above embodiments are described in the context of a program compiled for a source architecture on a platform having a target architecture different from the source architecture, one of ordinary skill in the art could apply the same embodiments in the context of a program compiled for a source architecture on another physical iteration of the platform having the same general architecture in order to optimize workflow across platforms. In a more specific embodiment, the platform may have a different configuration in the source architecture than in the other physical iteration of the platform.

### BRIEF DESCRIPTION OF THE DRAWINGS

FIG. 1 is a schematic representation of a runtime environment that supports the execution of legacy applications.

FIG. 2A is a schematic representation of a sequence of computer program instructions that were previously compiled for execution on a first legacy system architecture.

FIG. 2B depicts a sequence of computer program instructions, highlighting instructions to be replaced with native function calls to native APIs.

FIG. 2C depicts a sequence of computer program instructions, highlighting native function calls to replace selected sequences of instructions.

FIG. 2D depicts a sequence of computer program instructions, highlighting native function calls that have replaced selected sequences of instructions.

FIG. 3 is a schematic diagram of a system for executing a program compiled for a source architecture on one or more machines having a different architecture, with a cache adapted to enable just-in-time compiled basic blocks to execute in runtime environments under the different architecture.

FIG. 4A is a flow chart depicting the selection and execution of basic blocks compiled with a load module compiler.

FIG. 4B is a flow chart depicting the selection and execution of basic blocks compiled with a load module compiler using a bitmap to indicate the location of JIT-compiled blocks.

FIG. 5 is a flow chart depicting operation of the handling of self-modifying code in accordance with an embodiment of the load module compiler.

FIG. 6A depicts a pseudo-code illustration of a sequence of three program instructions that might appear in a load module.

FIG. 6B depicts the replacement of a function with a function of the legacy function library in accordance with an embodiment of the FIG. 6C depicts code illustrating the ability of the load module compiler to determine the address of a branch target and compile a basic block that extends beyond a branch to a branch target.

FIG. 7A depicts an illustration using legacy assembly instructions of and initialization sequence of a COBOL load module.

FIG. 7B depicts an illustration of an intermediate representation in the C programming language of a decompiled initialization routine.

FIG. 7C depicts an optimized invocation of an initialization function, inserted into intermediate representation of a basic block that includes a COBOL initialization routine.

FIG. 8 depicts an illustration of an intermediate representation of a library call, decompiled from a basic block of a load module.

FIG. 9 illustrates an intermediate representation of a call to a native API that replaced a legacy function.

FIG. 10 illustrates an intermediate representation of a call to an input/output routine that has similarly been replaced by a native routine.

FIG. 11 is a flow chart depicting operation of the handling of memory protection faults to implement lazy detection and bitmap creation of potentially self-modifying code in accordance with an embodiment of the load module compiler.

FIG. 12 is a flow chart depicting operation post-write operations to detect and track the execution of self-modifying code in accordance with an embodiment of the load module compiler.

FIG. 13 is a flow chart depicting a system that defers until runtime, the determination of whether to apply the lazy protection technique, or the default technique, for addressing self-modifying code by the load module compiler.

### DETAILED DESCRIPTION

The present disclosure provides a load module compiler that uses an intermediate representation. Some load module compilers are provided by the disclosure with an intermediate representation of a load module that leverages library components implemented for execution of a legacy application environment. Some load module compilers of the present disclosure may be able to generate native code that can be optimized for different target architectures, and that can support on-the-fly determinations of the desired target architecture. Some load module compilers of the present disclosure may optimize not only performance of individual legacy instructions or system calls, but also performance across multiple legacy instructions or system calls. Additionally, some load module compilers of the present disclosure can transcompile self-modifying programs. The present disclosure also provides a system to support the flexibility of just-in-time compilation, with the ability to reuse JIT-compiled blocks of code, outside of the immediate task or process. The present disclosure further provides a system that enables a load module compiler to create optimized code for replacing legacy ABI calls.

In one embodiment, an emulation environment (100) implements a legacy application environment (140) that provides a runtime environment in which legacy application programs may be executed. In one embodiment, the legacy application environment (140) includes a library of functions to support legacy instructions. The legacy application environment (140) may replace operating system calls and other functions with API calls that invoke optimized native APIs (135). The runtime environment, or a schedule operating in the legacy application environment (140), may identify a program, or a basic block within a program, as a candidate for runtime compilation by a load module compiler. The load module compiler may include a decompiler, which identifies basic blocks for translation, and invokes a library of functions to translate legacy hardware and software instructions into an intermediate representation. Preferably, the library of functions corresponds to the library of functions and native API calls used by the emulation environment. The legacy application environment may be thought of as a thin compatibility layer that allows legacy applications to make application calls. Though drawn to show that a legacy applications access native APIs (135) through legacy application layer (140), applications may also be written that access native APIs or host OS (120) calls directly.

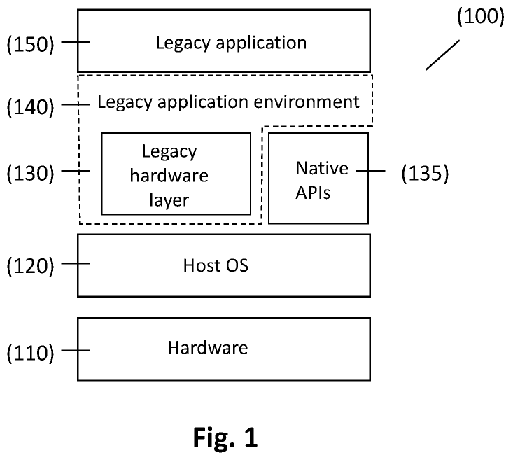

FIG. 1 depicts the operation of an emulation system operates on a host hardware architecture (110) such as an x86 or ARM architecture, running a host OS (120) such as Linux, with an legacy application environment (140) that provides a runtime environment to enable the execution of a legacy application (150) and which may include a legacy hardware layer (130). The legacy application environment includes implementation for support of hardware and software functions, preferably implemented in a library of C functions that implement legacy instructions, and a runtime environment that emulates the state and behavior of the legacy architecture. Other types of instruction sets and programming languages may be used. A legacy application (150) may take the form of a load module that was compiled for execution on a legacy architecture such as an s390 or z/OS mainframe.

The execution of complex instructions, such as the execution of operating system function calls, can be slow in emulation. By identifying such instructions, and replacing them with instructions to invoke native function calls through a set of Native APIs, the performance of an emulator can be significantly enhanced. In one example, sequences of instructions that invoke operating system calls are replaced with Execute Native Call (“ENC”) instructions to invoke native APIs (135), which run natively on the host hardware architecture (100). Preferably, a preprocessor substitutes ENC instructions prior to loading the legacy application (150) into the legacy application environment (140) of the runtime environment. In one embodiment of the inventive system, a system (100) provides runtime capability to emulate a legacy application environment. Libraries of functions written in a programming language such as C enable the emulation of legacy hardware and system calls by performing corresponding operations in the host environment.

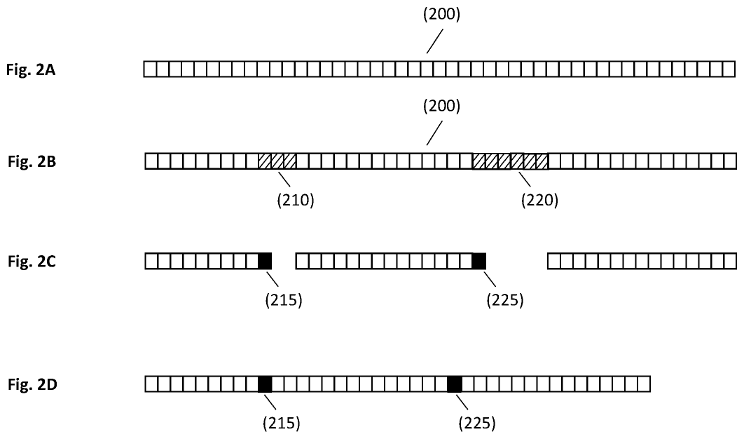

FIG. 2A depicts a sequence of instructions (200) that were previously compiled for execution on a first legacy system architecture. A COBOL load module is an example of such a program. FIG. 2B shows the same sequence of instructions, with subsets of instructions (210) and (220) identified as instructions to be replaced with native function calls to the native APIs (135). In one example, (210) corresponds to an operating system call, and (220) corresponds to a call to a library function. Other instructions or sets of instructions may be recognized as candidates for replacement by native system calls. FIG. 2C depicts the instruction sequence, with subsets of instructions (210) and (220) removed and replaced with Execute Native Calls (“ENC”) instructions (215) and (225) that invoke native APIs corresponding to the operating system call or library function. FIG. 2D depicts the modified load module, with the exemplary subsets of instructions removed from the load module. In one embodiment, the identification of candidate subsets of instructions, such as the operating system call (210) or the library function call (220) identified above, are performed by an offline preprocessing application, to prepare a load module for possible execution on the retargeted architecture. In another embodiment, the insertion of the ENC instructions is performed at runtime, when a load module is selected for execution in a rehosted target environment. The inserted ENC instructions (215) and (225) may, in some cases, be preceded with short sequences of instructions used to set up parameters for the ENC instruction. One pattern of instructions is a sequence of three sequential load instructions, followed by a branch instruction to direct the processor to the code implementing the ENC function. Other setup sequences, or different numbers of load instructions may be used.

The substitution of calls to optimized native functions for operating system calls and library function calls in a load module may improve performance in an emulation environment, but the introduction of the substituted ENC instructions can present a complication for a load module compiler. In one embodiment, the load module compiler may detect an ENC instruction, allow the instruction to execute in emulation, and then proceed with JIT compilation of subsequent instructions in the load module. In another embodiment, JIT compilation may occur before execution.

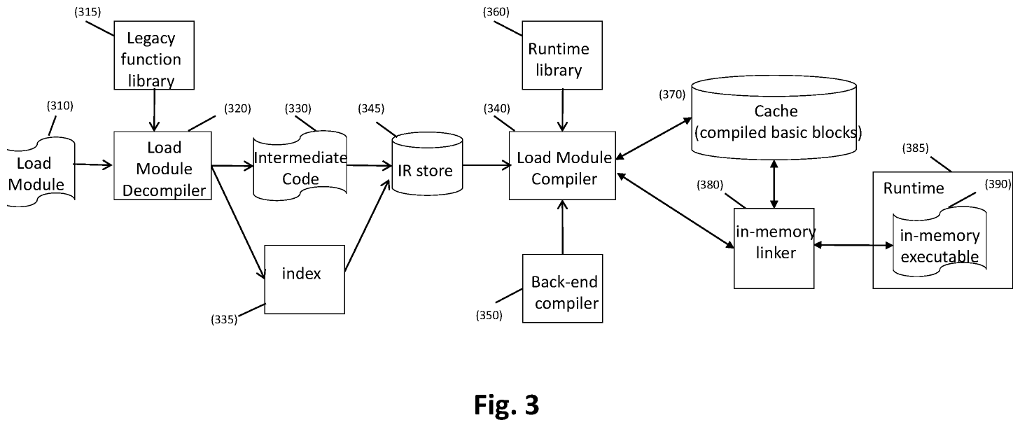

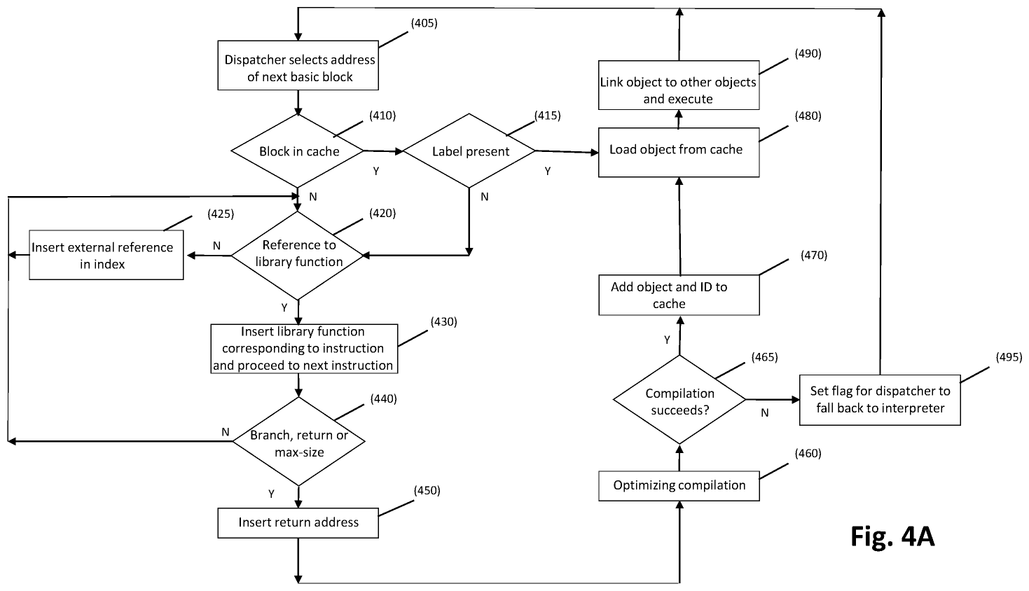

In another embodiment, a library of functions that implement legacy instructions, and a library of functions that implement ENC instructions is provided to the JIT load module compiler. When an instruction in the load module has a corresponding function in the library, the front end of the load module compiler incorporates the library function into the program. In some cases, recurring patterns of initialization instructions, followed by instructions that branch to code that implements a function may be emitted by the COBOL compiler. Similarly, when ENC instructions (215) and (225) are inserted into a load module to replace system or library function calls, those ENC instructions may be preceded by sequences of initialization instructions. The load module compiler may recognize such sequences of initialization instructions and replace them with a library function that includes the initialization instructions. For example, when an ENC instruction is identified, the JIT compiler identifies those instructions that set up the parameters required for the execution of the corresponding system call or library function call, and replaces those instructions and the ENC instruction with the ENC library function. In the context of a legacy COBOL program, the set up instructions typically concern the population of defined parameter data structures, and the placement of parameters or pointers to parameters in registers specified by the legacy architecture. Because this substitution is made at runtime, the parameter values and addresses are known to the system, allowing the JIT load module compiler to eliminate set up instructions. In one example a library of C program functions corresponding to legacy instructions and to ENC instructions is provided to a load module decompiler (320) (as depicted in FIG. 3).

Different patterns of initialization instructions may be used. In one example, a sequence of three loads and a branch instruction to the code implementing certain ENC instructions are inserted into the load module, and can be detected by the load module compiler and replaced with a corresponding function from the function library. In operation, the compiler recognizes the branch to the ENC instruction, and inserts the library function corresponding to the ENC instruction, which has been adapted to include the three load instructions used to initialize the ENC instruction. In another example, the load instructions and the branch to the ENC instruction are not included in the library function, and are included in the decompiled basic block by the decompiler. Some ENC instructions used with COBOL or PL/1 functions may be initialized with two or four load instructions rather than three load instructions. In such cases, the load module decompiler (320) can recognize the corresponding sequence of load instructions for a particular ENC instruction. Other initialization patterns may be used. The load module decompiler (320) may similarly recognize the sequence of instructions, such as a sequence of load instructions or other set up instructions, that precede an in-lined function that had not been replaced by an ENC instruction.

Referring now to FIG. 1 operating as shown in FIG. 3, the legacy application environment (140) includes code to support a legacy runtime environment, and a set of functions that implement the behavior of legacy instructions. In one embodiment, legacy hardware instructions are supported by a legacy hardware environment layer (130), and system and other library functions are supported by a set of native APIs (135). For example, the legacy architecture may be an s390 or z/OS legacy mainframe, and the emulator preferably includes a set of APIs to invoke optimized native routines and a set of C functions that collectively implement the behavior of each legacy instruction. In one embodiment, the set of C functions and source C for the implementation of the APIs of the emulation environment (100) are processed by a compiler front-end, such as clang, the LLVM frontend used for the C programming language, to translate the APIs and C library into a legacy function library (315) in an intermediate representation suitable for optimization at runtime. In one example, the clang front end generates the legacy function library (315) using the LLVM IR as its intermediate representation. In one embodiment, the legacy functions and elements of the legacy function library (315) may are stored in an optimized LLVM IR representation in an intermediate representation store (345) The legacy function library may also include common functions that have been optimized for use with Cobol, PL1, or other applications. In another embodiment, some of the native APIs (130) are not included in the legacy function library (315) and are instead included in a runtime library (360) for use by the load module compiler. Many of the native functions are invoked using discernable patterns of load instructions to set up the parameters required to execute a particular function. In one optimized configuration, such functions in the legacy function library (315) are written to include initialization sequences, such as sequences of load instructions, and a branch instruction used to invoke the function. The legacy function library (315) may include copies of optimized legacy functions that include the initialization sequences, and copies of the legacy functions that do not include the initialization sequences. In operation, the load module compiler can be configured to apply the optimized set of functions, or the unoptimized set of functions. In another embodiment, the selective use of optimized functions and non-optimized functions may be made at run time, but such an application increases the overhead of the load module compiler.

As explained above the sequence of initialization instructions that precedes a particular function emitted by the legacy COBOL compiler may vary, depending on the version of the compiler used. In one embodiment, the library functions in the legacy function library (315) may be written to selectively include differing sets of initialization instructions. Depending on the compiler version, which may be determined using CSECT metadata, a corresponding set of initialization instructions may be selectively included in by the function in the function library. Since the substitution of functions from the legacy function library (315) into the CSECT happens at runtime, the compiler version information is available to the load module decompiler (320), allowing such compiler-specific optimization.

At runtime, the decompiler (320) of the load module compiler first identifies a basic block for just-in-time translation and execution. A basic block is typically a sequence of instructions that do not branch outside of the basic block, and is ended by a branching instruction to another subroutine or return. Non-branching instructions can be used to load, store, or move data among memory and registers, and to perform computations such as addition or shifts on the data. A branch or terminator instruction is an instruction that determines where to transfer control flow, such as a return or branch instruction, which may change control flow conditionally or unconditionally. Absent an externally driven interruption or error condition, the sequence of instructions will proceed from beginning to end without interruption. Using the legacy function library (315), the decompiler (320) translates the legacy instructions into an intermediate representation (330) and index (335).

In one embodiment, the load module decompiler (320) performs initial optimizations on the basic block. In one embodiment, the load module decompiler (320) includes a program routine to parse an overlay data structure generated by the legacy compiler that created the load module, to identify the CSECTs within the load module (310). The load module decompiler (320) may also include a program routine to parse the identification record associated with a CSECT, to identify the language and version of the compiler used to generate the corresponding C SECT within the load module. A load module (310) may include one or more CSECTs, and the different CSECTS may be stored in non-contiguous memory locations. Based on the compiler and/or version information obtained from the identification record, the load module decompiler (320) may selectively apply optimizations specific to the corresponding source language, or to the compiler. As explained above, one example of the use of compiler version information may be the selective inclusion of corresponding initialization sequences in a function from the legacy function library (315). For example an initialization sequence might use a load address instruction, rather than a load half word immediate instruction, as part of the initialization sequence. In another example, different instructions may have been emitted by the compiler because different versions or sub-versions of the compiler may support different instruction sets. For example, if a new compiler version or sub-version makes uses of processor instructions that were not previously available, the CSECT compiled with the newer compiler may make use of previously unavailable instructions.

In one example, the load module decompiler (320), upon detecting that a s390 COBOL compiler was used to create a CSECT, may identify a sequence of initialization instructions at the beginning of the CSECT, and substitute one or more initialization functions corresponding to the initialization sequence, rather than in-lining functions corresponding to the individual instructions or system calls that make up the initialization sequence of the CSECT. To improve performance, the corresponding initialization sequence or sequences were preferably pre-compiled into optimized LLVM-IR code, and included in legacy function library (315), though they may also be stored in a separate store accessible to the load module decompiler (320). The load module decompiler (320) may also omit labels for entry points. Application binary interfaces (ABIs) may also be removed by the load module decompiler (320) as the insertion of replacement functions, either from the legacy function library (315), or calls to external functions in the runtime library (360). As described above, one common application binary interface is the use of a sequence of load instructions that load parameters or pointers to data structures containing parameters before a branch to the corresponding library function. Other application binary interfaces, with different sequences used to initialize a function may be used.

In some cases, the ABI used by a particular function of in the legacy function library (315) may vary, depending on the version or sub-version of the compiler used to generate the CSECT. In such cases, the library function may be configured to selectively include corresponding set up instructions, as a function of the compiler version number. In such an implementation, the load module compiler may flatten differences between different compilers, making the execution of such code transparent to the compiler version used with the code. This automatic identification of, and inclusion of the appropriate ABI in the code is particularly helpful where the legacy code or the details of its compilation are poorly documented.

In some situations, the version level of the compiler may be insufficient to identify important differences in the emitted code. For example, where a compiler version has been updated to fix a known problem, the emitted code of the updated compiler will differ from code emitted previously. In such instances, reference to the compiler sub-version number may be required, for example, for the decompiler to recognize which ABI may have been used to set up the parameters used with a subsequent instruction or a library call.

In addition to the version or sub-version information obtained from the CSECT, the load module decompiler (320) may also use information obtained about the level of optimization applied by the compiler that generated the load module. Using the optimization level, the load module decompiler (320) may identify blocks of code that were optimized for the source machine, and translate them into an intermediate code representation (330) that either modifies or undoes the optimization, enabling the load module compiler (340) to apply its own optimizations that are suited to the target platform. For example and as further described herein, the load module decompiler (320) may detect an unrolled loop, and may opt to extend the size of the basic block to include a larger portion of the unrolled loop, or possibly the entire loop, even though such inclusion would expand the size of the basic block. In one embodiment, the decompiler may invoke a process to reroll a previously unrolled loop, or part of such a loop, generating an LLVM representation of the CSECT containing an unrolled loop. By doing this rerolling, the load module compiler (340), or one of its optimization passes, cane emit code that is optimized for the target platform.

The next stage of the load module compiler (340) receives the intermediate code (330) and index (335), and invokes a compiler (350) to generate executable code for the target architecture. A runtime library (360) is accessed to obtain external functions to be linked with the executable output of the load module compiler (340). The executable is then stored as an object in the cache (370) where it becomes available to the runtime environment (385).

When a call is made to a basic block that is present in the cache (370), the load module compiler must verify that the label used to call the block is present for the cached, JIT-compiled basic block. If the label is present, the load module compiler (340) invokes the in-memory linker (380) to link the compiled basic block to the in-memory executable (390). In one embodiment, the cache (370) resides on a POSIX-compliant architecture that permits shared access to the cache among multiple processors. Entries in the cache may reference the load module, CSECT, basic block, object ID, the processor type, instruction set identifier, or hashes of such values. The in-memory linker (380) retrieves the compiled basic block from the cache and links it into the in-memory executable (390) for execution in runtime environment 385. Alternatively, the sharing of cache (370) may be limited to a specific processor type, and a separate cache of compiled objects may be maintained for each processor type in the heterogeneous environment.

In a just-in-time implementation, basic blocks are compiled as they are encountered during the execution of a load module (310) by a runtime environment (385). By persisting the life of entries in the cache (370) beyond the life of the process executing the load module, a hybrid approach enables the runtime environment (385) to access previously compiled basic blocks and just-in-time compiled basic blocks during program execution.

The bits in a register or other storage location may reference an individual memory location, such as a byte of memory. Blocks of size other than a byte can be used, and often are used in referencing the contents of disk storage, caches, or other types of data stores. Bytes addresses have most frequently been used with microprocessors. Where the bits indicate the address of a byte in memory, the number of bits determines the extent of memory addressable to the processor. A 32-bit instruction can access a maximum of 2 to the 32nd power or 4 gigabytes (4,294,967,296) bytes of memory, whereas a 64-bit instruction set can theoretically access 2 to the 64th power or 16 exabytes (17,179,869,184 gigabytes) of memory, though for practical reasons, a smaller maximum virtual address space is often used. Executable computer programs, such as the load modules (310) that have been compiled to use 32-bit addresses, require that the addresses be translated into 64-bit addresses, if they are to run on a machine that uses a 64-bit instruction set.

When the load module compiler (340) converts the intermediate code representation retrieved from IR store (345) into object code including x86 instructions for assembly into an x86 executable, the entries in the index corresponding to 32-bit addresses in the address syntax are inserted into the object code generated by the compiler (340), rather than inserting 64-bit addresses of the target architecture for those entries. The entries in the table are not given an absolute address, but are assigned an external reference which the in-memory linker (380) may then assign to 64-bit addresses allocated to the executing, compiled program. In one embodiment, index location zero is reserved as invalid, and the index of externally referenced addresses begins at location one. In one embodiment, the Memory Management Unit (MMU) responds to an attempt to access instructions at the lowest addresses, which have not been allocated to the user space of the program, by causing the Linux operating system to generate a SEGV signal to invoke the exception handler. The exception handler is configured to access the index of 32-bit addresses and to translate the 32-bit address into a corresponding 64-bit address used by the compiled executable program. The exception handler may be performed to perform additional verifications, such as to support protection key management of memory addresses. An example of an exception handler and of prefixing schemes to perform such functions is described in PCT application PCT/IB2015/059646 titled “Protection Key Management and Prefixing in Virtual Address Space Application.”

In one exemplary embodiment, for which there were fewer than 16k addresses that were potentially externally referenced, the external references will be to addresses ranging from 0000 0000 0000 0000x to 0000 0000 0000 3FFFx. Because this range of addresses was not assigned to the program, an attempt to execute an instruction at these locations invokes the MMU and exception handler, which will determine the correct address and then retry the instruction at the proper address. Other sizes may be used. Where only the lower 4k addresses were unused, the range would be from 0000x to 0FFFx. In an 8k embodiment, the range is 0000x to 1FFFx. In another example, where ARM Linux is used, the default page size is 64k, and accessing the bottom range of addresses from 0-64k may similarly invoke the exception handler. Different ranges of addresses, or ranges of addresses that begin with a base address other than zero. In one embodiment, the load module compiler may generate pseudo-addresses, and implement a branch table to translate the pseudo-addresses of the load module compiler into 64-bit addresses used by an underlying Linux platform. As further described herein, the exception handler may also be configured to detect attempts to write to addresses in the program address space, and to handle such self-modifying code.

Legacy mainframe systems, such as the System/360™, System/390™, or System/Z architectures use storage keys to implement different levels of protected access to different portions of memory. The storage keys are typically stored in a table that has a control byte associated with each 4 KB block of memory, and a control byte containing a storage key is associated with each physical page of memory. Such a control byte may be structured to contain a four-bit field that indicates the protection key in bits 0-3, a protect bit is stored in bit 4, a change bit in bit 5, and a reference bit stored in bit 6. The setting of the fetch bit may indicate whether the protected status of the associated block should apply to both reads (fetches) and write accesses (stores) to the block. In this example, where for bits are used to encode the protection key, there are 16 protection keys numbered zero to fifteen. The protection key associated with a given task running on the processor is stored in the program status word (PSW) and is referred to as a storage access key. In operation, the system checks whether the storage access key in the program status word permits access to the protected memory. When the storage key does not permit access, storage protection logic will interrupt the task and initiate a protection exception.

In one embodiment, to provide support for protection keys, the interrupt handler of the LINUX® (Linus Industrial, Massachusetts) system on which the runtime operates is modified to support key verification. The key verification routine compares the storage access key associated with the current task to the storage key in an associated control byte to see whether the keys are equal. If the key verification routine determines that the key does not match, and if the access key is other than zero, then the system denies access and does not execute the instruction. If the key matches or is not zero, then the operation is permitted.

In operation, if the x86 executable refers to an indexed address, the runtime system uses the index to identify the 64-bit address of the corresponding instruction. However, a 32-bit program that has not been recompiled may still generate a 32-bit address. When a program attempts to address the lowest portion of the address space, an exception is generated and the memory exception handler performs the necessary address translation.

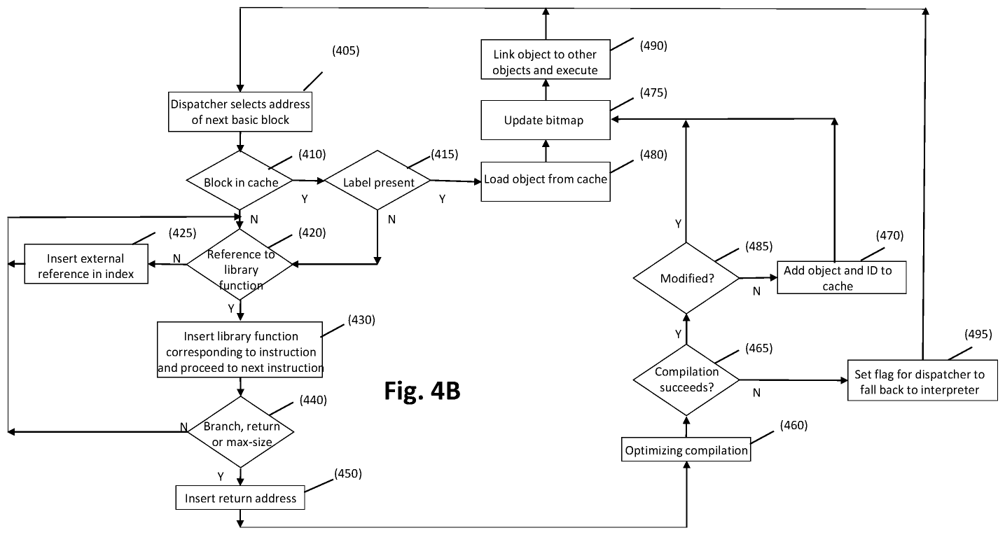

The linking and execution of compiled basic blocks is depicted in FIG. 4A. Beginning at step 405, the dispatcher selects the start address of the next basic block, and at step, the cache (370) is queried at (410) to determine whether the compiled block is present. If present, the dispatcher verifies that the label used to invoke the block is also present at step (415). Compiled code for a basic block may lack a necessary label, for example, if the instructions associated with that label were identified as dead code, and optimized out of the basic block, when the basic block was previously invoked elsewhere in the load module. If the necessary label is present, in-memory linker (380) loads the corresponding object from the cache (480) and links it to the other objects (490), and the program executes in the runtime environment (385). If at step (410) the block is not present in the cache, the dispatcher may optionally check one or more flags (not shown) to determine whether to proceed with compiled execution, or whether to dispatch execution of the block to the interpreter. A block may have been previously designated to run in the interpreter, or the system may optionally be configured to use a flag or counter to determine when to invoke the compiler. In one embodiment, upon encounter of a block not previously executed, the complier is presumptively used. If at step (410) the block is not present in the cache, or at step (415) the label is missing, the load module decompiler (320) retrieves the code for the next basic block from the load module (310). The decompiler (320) parses the executable instructions of the load module (310), and replaces instructions with optimized LLVM-IR code corresponding to each instruction that it retrieves from the legacy function library (315).

In one embodiment, the code in the legacy function library (315) includes code that implements functionality corresponding to legacy instructions for a legacy application environment (140), where the code corresponding to each function of system operation is compiled from a source language such as C into optimized LLVM-IR code. By replacing legacy instructions or system calls with optimized LLVM-IR functions, the load module decompiler (320) generates a representation of the basic block in LLVM-IR, and an index (335) of LLVM IR labels. In one embodiment, the load module decompiler (320) recognizes values that are loaded into registers and subsequently used as branch addresses or passed to external routines, and includes corresponding labels in the index (335). Preferably the labels of the index (335) are LLVM-IR labels.

To identify the basic block, the load module decompiler (320) examines each instruction, determining whether it references a known library function or an external function. In the case of an external reference, the load module decompiler (320) inserts and external reference in index (425) and proceeds to next instruction. In the event a library function is detected (420), the code corresponding to that instruction is inserted (420), and the load module compiler proceeds to the next instruction (430). If the next instruction is a branch, return, or, in the event that code length is used to defined the basic block, reaches the maximum allowed size at step (440), the load module decompiler (320) inserts the return address (450) indicating the end of the basic block, and the LLVM-IR representation of the basic block (330) and its index (335) are stored in intermediate store (345). As described below, rather than simply identify a branch or a threshold number of instructions that indicates the end of the basic block, additional criteria, such as the identification of a nested set of branches, or detection that the decompiler is processing an unrolled loop, may result in the decompiler looping back to step (420), and processing further instructions. Where the system allows a set of nested loops, or allows the processing of an unrolled loop to extend the size of the basic block, the completion of the identified nested loops, or the completion of an unrolled loop, or a portion of an unrolled loop, may be detected at step (440).

In one embodiment, a basic block is selected by beginning with the address first instruction identified by the dispatcher (405), with the load module decompiler continuing to include subsequent instructions from the load module (310) until a branch is detected at step (440). The load module decompiler (320) in-lines individual functions taken from the legacy function library (315). Additional functions, such as library routines that implement mathematical operations, or other types of library functions, may also be compiled into an intermediate representation and included in the legacy function library (315). By constructing a basic block that includes code from multiple functions, the decompiler (320) enables the load module compiler (340) to perform optimizations that occur across functions.

In some cases, a basic block may extend beyond a branch instruction. In one embodiment, a basic block is selected by beginning with at a first instruction and continuing through a sequence of subsequent instructions of the load module until a branch instruction to an instruction whose address is not one of the earlier instructions in the same sequence. A substantial fraction of compute time in a typical program is spent in loops, and this embodiment permits the generation of code to optimize loop execution. In one embodiment, the definition of a basic block may be expanded to encompass nested sets of branches, to enable the use of loop optimizations by the back-end compiler. In one embodiment, a parameter may be set to define a maximum allowed length or a maximum allowed number of instructions. The logic of the load module decompiler may include code to recognize instructions or sequences of instructions that save state, and a basic block selected such that its length is less than the value indicated by the parameter, and concludes upon the execution of a memory write or other instruction to preserve state. A sequence of memory write operations, may also be identified for the termination of the basic block. Basic block selection logic may, in some instances, examine branches, a maximum allowed length, and recognition of state saving sequences of instructions.

The determination of the optimal length of a basic block may also be made, based in-part, on the optimization settings used when the original C SECT was compiled. For example, some versions of a COBOL compiler permit the use of optimization settings that will unroll loops for performance reasons. In the case of a very large loop, the compiler may have taken considerations such as the cache size of the legacy machine into account, in order to determine the number of iterations of a loop that should be unrolled into a particular block of code. While such compiled code may have been optimized for performance with a specific legacy machine configuration, the size of the available cache memory in the target machine in which the load module compiler is running may be very different. In one embodiment, the selection of a basic block in accordance with FIG. 4B may be increased, beyond the branch instruction detected at (440), to include multiple iterations through the loop, or even all iterations of the loop. In another embodiment, the load module decompiler may be configured to detect the presence of an unrolled loop in the code, and to reroll a portion of, or the entire loop, storing in the intermediate store (345), a representation of the CSECT that includes a rerolled loop. This rerolling of loops by the decompiler enables optimization routines of the load module compiler to unroll the rerolled loops in a manner that is optimized for performance on the target machine. In one example, the load module compiler unrolls loops in the decompiled CSECTs to ensure that the newly unrolled portions of the code fit in an instruction cache. For example, the ARM cores of a high-performance M1 processor may have an instruction cache of 192 kB, while a particular Intel processor may have an instruction cache of 64 kB. By deferring the extent of loop unrolling until a CSECT is running in the load module compiler, the extent of the unrolling can be optimized at runtime. Processors may be expected to have larger caches in the future. Whether the cache size is increased or decreased, the load module compiler enables adaptive recompilation of the CSECTs to take advantage of, and optimize performance, of the runtime machine. In cloud deployments, where the instruction cache size may vary from machine to machine in a provisioned cloud instance, this dynamic optimization enables increased system performance. Where the decompiler detects an unrolled or partially unrooled loop, such as by identifying a sequence of code that repeats, with a changing index value, the decompiler may scan ahead to determine where the unrolled loop ends, before proceeding at step (450) to insert the return address.

In another example, the decompiler may detect that a load module was compiled to optimize to natively managed data types, or to modify initialization sequences, such as by loading data once and moving it to another register to initialize multiple fields, which may modify the code emitted by the legacy compiler. By detecting that such optimization settings were set, the load module decompiler (320) may insert suitably optimized functions from its legacy function library (315).

The decision as to how to limit the extent of a basic block is generally based on performance considerations. In some cases, rather than selecting the size of the basic block by proceeding to the next branch instruction, a basic block may be selected using a maximum permitted code length setting, or by using labels of other routines that call into the basic block. By allowing a basic block to extend beyond a branch instruction, the load module compiler can perform optimizations that span across the branch instruction. The insertion or in-lining of functions (430) into by the load module decompiler (320) may include the insertion of recursive functions into the basic block.

CSECTs generally include many basic blocks. Unlike a typical compiler, which translates an entire program from source code into an executable program, the load module compiler parses an executable load module to identify a next basic block, generates and LLVM-IR representation of the basic block, and then invokes a back-end compiler to generate an executable corresponding to the basic block, which is stored in the cache and may execute in the system runtime. By operating on basic blocks, rather than entire programs, the load module compiler enables the benefits of optimized just-in-time compilation that spans multiple program statements, without the loss of flexibility of a load module compiler design that must compile an entire program before execution may begin. In one embodiment, the load module decompiler (320) may allow the expansion of a selected basic block beyond the maximum permitted code length, to accommodate an unrolled loop. In another embodiment, the load module decompiler (320) may reroll the loop, or portions of the loop, both to reduce the size of the basic block, and to enable optimization by the load module compiler (340), which may unroll the loop differently, depending on the target processor, or the size of a cache of the target processor. In one embodiment, the size of the instruction cache may determine the desired level of optimization. In another embodiment, the size of a second level cache, or the amount of RAM in the configured target machine or container may be used.

In embodiments that permit the size of the basic block to extend beyond a branch, return, or a threshold max size as described above, the load module decompiler (320) may scan forward, to identify conditions that favor selection of a larger basic bloc. For example, where nested sets of loops are permitted within a basic block, the load module decompiler (320) may determine the extent of the nested set of loops with reference to index variables or repeating branch addresses. Where an unrolled or partially unrolled loop is selected to be within a basic block, the load module decompiler (320) may scan ahead to detect repeating sets of instructions with a varying index variable, and continue to iterate through steps (420) and (430) until the end of the loop is reached at step (440) before inserting the return address (450).

In the event that the load module decompiler (320) encounters an instruction or sequence of instructions that it cannot decompile, the load module decompiler (320) may be configured to set a flag or return a parameter indicating to the dispatcher that subsequent execution of the load module (310) should fall back to the emulation in the legacy application environment (140).

A back-end compiler (350) performs the optimizing compilation (460) of the LLVM-IR representation of a basic block stored in intermediate representation store (345), to create an executable object corresponding to the basic block. The executable code may be x86 code, ARM code, or code of another target architecture. If the compilation succeeds (465), the load module compiler (340) checks whether the newly compiled block is one that has been self-modified (485), and if so, returns to execution. If the newly compiled block was not modified by the CSECT, the load module compiler (340) adds the object and its corresponding ID to the cache (370) at step (470). The in-memory linker (380) then loads the object into the in-memory executable (390) in the corresponding runtime environment (385). Because the object and ID are already in memory, the system may proceed with the in-memory copy rather than load the object from the cache. Using the in-memory copy only for execution of the self-modifying code ensures that if another program accesses the same basic block, it will not initiate execution of the block in an undetermined state. If compilation fails at step (465), the load module compiler (340) sets a flag directing the dispatcher to fall back to interpreted execution (495) for the basic block. Alternatively, the flag could be cleared, or simply not set, if the flag were defined such that a set flag indicated use of the load module compiler, rather than the interpreter.

The load module compiler (340) preferably carries out a sequence of transformation passes that analyze the code for the basic block and optimize the code's performance. In one embodiment, an LLVM optimizer translates the LLVM IR code received from IR store (345) into optimized LLVM code and stores the optimized executable code corresponding to the basic block in cache (370). In one embodiment, the cache (370) is shared among multiple processors, but is ‘indexed’ by processor type. Sharing the cache by multiple processors allows multiple runtime environments (385) to re-use previously translated basic blocks.

The generation of executable code, optimized for a specific back-end architecture is preferably performed by a back-end compiler (350) by the load module compiler (340). In one embodiment, back-end compilers (350) for both the x86 and ARM environment are dynamically selected at runtime. In one embodiment, the cache (370) is further indexed by the different sets of extension instructions to the x86 or ARM architectures, and back-end compilers (350) that include different sets of extension instructions of the x86 or ARM architectures may be used to generate corresponding code. Though the process of compiling the basic block by the load module compiler (350) may be serialized, it is also possible to perform parallel compilation using multiple back-end compilers (350) to produce a set of objects in the cache (370) for use with different target architectures. By preventing multiple threads from compiling the same basic block, consistency of the cache is maintained and performance of the system improved. In one embodiment, compilation of an individual basic block is serialized to prevent inconsistent system behavior. In this embodiment, parallel operations are permitted involving the compilation of different basic blocks. Alternatively, parallel operations on the same basic block may be permitted where other methods of ensuring cache consistency are employed.

The execution of a segment of legacy program code involves the invocation of a sequence of different functions. If a load module compiler compiles and executes each function individually, the execution of the code requires calling and returning from functions for each instruction. By incorporating the functions themselves in a library, the load module compiler can significantly improve code optimization by in-lining function calls, thereby reducing the overhead of sequential jumps to different functions.

When a function call is separated from a basic block, the runtime environment must push parameters onto the stack, pull them off the stack, and execute the function separately from the calling routine. However, where the function is in-lined, the load module compiler can avoid this overhead. In addition, when the execution of a function is separated from that of the calling routine, the function must compute and return all of its output values, even if some of those values are not used. When the function is in-lined, the load module compiler can identify code that produces an unused value or values and remove it to improve performance. Because the load module compiler (340) operates on basic blocks obtained from IR store (345) that typically include many in-lined functions, the load module compiler (340) can perform these and other optimizations.

Many legacy program instructions make use of constants, or of computed values that are known or can be known at compile time. When such constants or computed values are determined and used in a sequence of program instructions, the LCM can use constant propagation, substituting the values of constants directly into the code at compile time. This technique is not available to a load module compiler that identically implements the behavior of each instruction. By enabling the load module compiler to optimize code across a calling block and a function, or across a series of function calls, the constant propagation becomes available to optimize code execution within a basic block.

In another example, some code segments perform multiple loads or stores to the same memory location. Where a program may be interrupted, these operations may be necessary to ensure that the runtime environment maintains a valid state. However, interim loads and stores to memory locations can be eliminated, where the register containing the value of interest is known to the compiler. Similarly, instructions to allocate memory to store the interim values, or data structures containing these values, may be eliminated across the basic block. In this way, a sequence of loads and stores to memory may be eliminated, and the optimized code need only store the final result back to memory.

A feature of some compilers is the use of specific registers for known tasks. For example, in s/390 and z/OS Cobol programs, register 15 is often used to carry the contents of a so-called RETURN-CODE. A calling routine can thus make use of the RETURN-CODE of the called routine by reading register 15, without the added overhead of the calling routine defining a parameter for the call, and the callee, in turn incurring the overhead of providing a parameter back to the caller. In one embodiment, the back-end compiler (350) of a load module compiler (340) identifies the use of register 15 to communicate a return code from a call function to the caller, and removes from the executable code, instructions associated with moving the return code between memory to register 15. In one embodiment, the load module decompiler (320) sets one or more flags to enable such optimizations by the load module compiler (340), using data identified by parsing a C SECT identification record containing metadata for the CSECT.

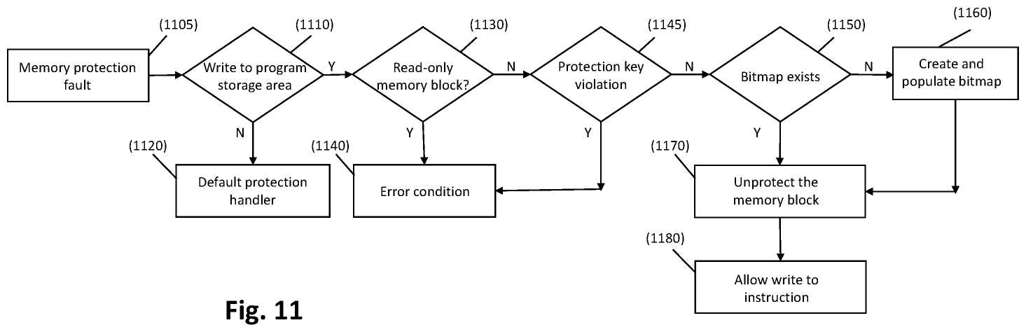

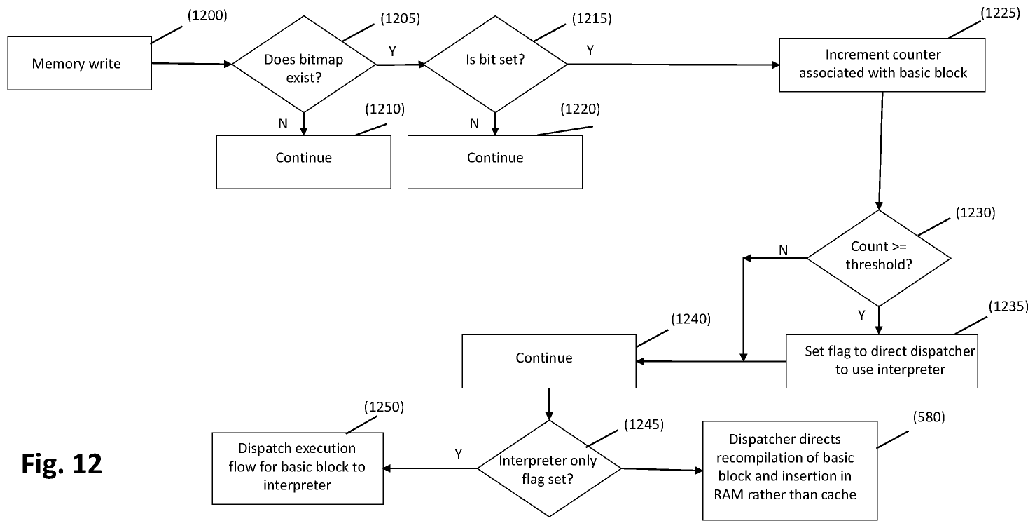

FIG. 4B depicts the linking and execution of compiled basic blocks as described with respect to FIG. 4A above, but with the inclusion of a bitmap to indicate the addresses of JIT-compiled blocks. Where a label was found present at step (415), in-memory linker (380) loads the corresponding object from the cache (480), updates a bitmap (475) indicating memory locations of the load module that correspond to the JIT-compiled code, and links it to the other objects (490), and the program executes in the runtime environment (385). In some embodiments, as a block containing JIT-compiled code is loaded from the cache, it is placed in protected storage to facilitate detection of subsequent attempts to modify the block. In some embodiments, the bitmap will only have been created for programs that have modified their own instructions, and step (475) is omitted where the load module has not modified its own instructions. By populating the bitmap so that only those addresses corresponding to instructions that were successfully compiled, and by deferring the creation of the bitmap until an instruction modifying the program's own code has executed, the execution time for JIT-compiled blocks is considerably improved. The creation the bitmap (or other data structure indicating the addresses of instructions compiled by the load module compiler), and its use is further described with respect to FIG. 11 and FIG. 12 below. In the case that a basic block was newly JIT compiled, after determining that a basic block has been successfully compiled (465), a flag is checked to see whether the block has been modified (485). If the block has not been modified, then the object and its ID have are added to the cache (470). Next, the bitmap indicating the memory locations of the load module corresponding to the JIT-compiled blocks is updated (470) to include the newly compiled block, and the in-memory block is then linked by the in-memory linker (380) for execution by the in-memory executable (390) at step (490). In embodiments for which the creation of the bitmap follows the execution of self-modifying instructions, then step (475) is omitted where the load module has not previously modified its own instructions.

In one embodiment, when the runtime begins execution of a CSECT that has previously been compiled using the load module compiler, some of the basic blocks will be persistently stored in the cache (370), and the load module, together with those compiled basic blocks that are in the cache, will be loaded into protected storage and linked. While it is possible that the execution of the program might not use all of the basic blocks that were compiled during a prior execution, loading and linking such blocks reduces the overhead that would be incurred if linking the previously compiled basic blocks was delayed until runtime. For example, steps 415, 480, 475, and 490 would not need to be repeated while the application is running as each previously compiled basic block is encountered, where the cached basic blocks are loaded ahead of time.

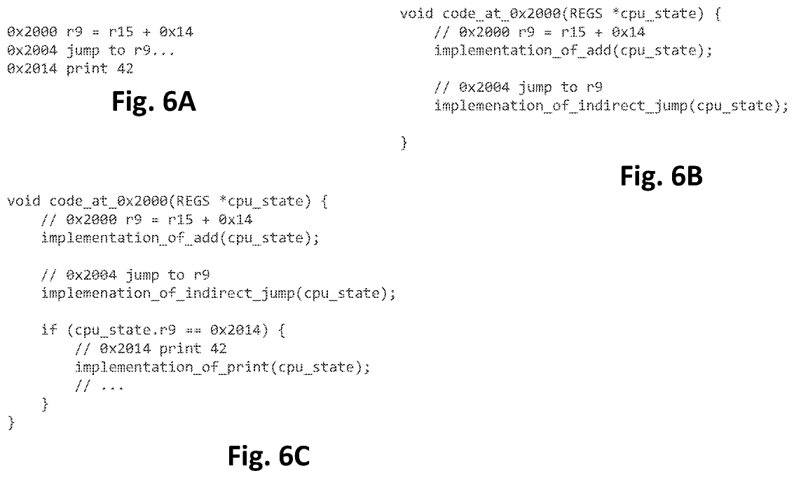

FIG. 6A is a pseudo-code illustration of a sequence of three program instructions that might appear in a load module. The first instruction at 0x2000 computes the sum of the contents of register 15 and the literal value 0x14, and stores the result in register 9. The second instruction jumps or branches to the location stored in register 9. The third instruction prints the number 42. When processed by the decompiler (320), the first instruction, 0x2000, is replaced by a code in legacy function library (315) that implements the add function that has been individually compiled from source code into optimized LLVM-IR code. Similarly, as depicted in FIG. 6B, the second instruction at 0x2004 is replaced by a function from the legacy function library (315) that implements the jump function, and was similarly compiled from source code into optimized LLVM-IR code. Ordinarily, JIT compilation would be limited by the fact that the jump location of register 9 is not known. However, the where the load module decompiler detects that the load module (310) was compiled using the s390 Cobol compiler, the compiler is aware that register 15 contains the return value of a called program upon exit and the entry point of the called program when it is invoked, meaning that the target address of the jump instruction x2004 of FIG. 6A is known because the value of register 15 is known. In the example of FIG. 6C, the print instruction is executed upon detection that the location of r9 points to the print instruction at 0x2014. In this example, since the return address is known by the compiler, the compare instruction can be removed and the output “42” printed.

In one embodiment, the decision as to the execution architecture is fixed, and a dedicated back-end compiler for the target architecture is used. In another embodiment, the decision as to the target architecture is made at runtime, and a flag informs the load module compiler which of a set of multiple back-end compilers should be used. For example, the decision use a different back end compiler to translate optimized LLVM IR code to x-86 or ARM architectures could be made at runtime. The runtime decision may, for example, support deployment to different versions of the x-86 or ARM architectures, which support enhanced or modified instruction sets. Other instruction architectures, such as MIPS, PowerPC, NVIDIA, Qualcomm Hexagon, or even legacy architectures such as S/390 or z/OS instruction architectures may be used.

In one embodiment, back-end compilers (350) may be adapted to generate legacy S/390 code using different instruction extension sets may be employed to assess the performance impact of the use of different instructions, or the compatibility of applications with architectures running different legacy instruction set architectures. In some cases, some of the functions needed to implement the behavior of, for example, the s390 instructions require calls to external run-time functions. In such cases, the output of the back-end compiler must be linked to the executable external run-time function. Such an application may be particularly useful where the availability of a legacy test environment, or the ability to execute a legacy test environment under a specific set of conditions is limited. Another application is the performance of backward-compatible translation, as may be desired in order to migrate an application to a system whose architecture lacks support for some instructions.

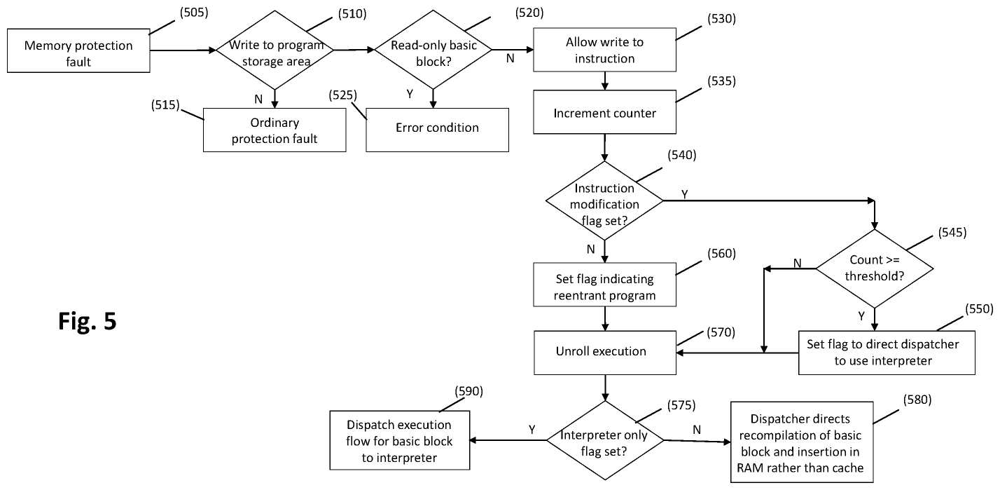

Just-in-time compilers typically cannot address self-modifying code. In one embodiment, the load module compiler is equipped to accommodate self-modifying code. The compiler places the compiled executable code in a protected range of memory addresses. When an instruction seeks to write to a memory location containing instructions, a memory protection exception is thrown. In the embodiment depicted in FIG. 5, the exception handler includes code to implement logic to recognize an attempted write to the range of addresses containing the executable code, and to allow the change. Having thus permitted the change, the revised code can be provided as an input to the just-in-time compiler, to recompile with the modified code. In the event that the number of such modifications exceeds a defined threshold, or in the event of repeated modification of the same line of code, the JIT load module compiler may terminate JIT compilation of the basic block or of the program, where the overhead of supporting the self-modifying execution is too great.

The inventive design of the JIT load module compiler depicted in FIG. 3 can also be applied to applications of modifying binary executable load modules for native redeployment on a legacy architecture. In such applications, the target of the backend compiler (350) is a legacy architecture such as the s390 or z/OS instruction set. Retargeting the application using different sets of instruction set extensions by the back-end compiler can also be used to compare the performance of the application using different instruction sets. By configuring a container to execute the same runtime, with the same workloads, performance differences due to the inclusion or exclusion of a specific set of enhanced instructions can be measured, and the results used to determine the optimal instructions for use with the application.

For example, where a particular program is bound to a legacy processor, the load module compiler select a backend compiler (350) to target the JIT-compiled program to the original instruction set (e.g. s390 or z/OS), or to the legacy instruction set to which the application is bound. Preferably, in such instances, the load module decompiler (320) would detect that the target environment is a legacy architecture, so that different legacy function libraries (315) might be included where necessary, to accommodate the native legacy environment. In one example, the load module compiler might direct its output to execute in a runtime environment instantiated in, for example, a Z/OS Linux instance. Such an implementation may be used in a production environment, or in a test environment, such as for the verification of a new component or peripheral, or to otherwise validate the interoperability of the legacy load module with other systems.

An illustrative embodiment of modifications to the memory protection handling of the system to accommodate the handling of self-modifying code by the load module compiler is shown in FIG. 5.

Where instructions compiled by the load module compiler attempt to write to a location in memory containing program instructions, a memory protection fault will be detected, invoking the exception handler (505). This exception may be triggered, for example, where the memory assigned to the CSECT containing the basic block in question is protected memory. The exception handler determines whether the attempted write is to a program storage area (510), which will be the case of self-modifying code. If the write is not to a program storage area, then the handler operates as it would for an ordinary protection fault (515), as might occur due to a need to access virtual memory, handling protected memory access, or for other reasons. After determining that the write is to the program storage area (510), an indicator is checked to determine whether the basic block is a read-only block (520). In one embodiment, the indicator that the cached basic block is designated a read-only block was associated with the cached basic block identified by the decompiler module (320) reading metadata associated with the load module, and placing a corresponding indicator into IR store (345). The indicator could also have been set after compilation, or stored outside of the cached basic block, in a data structure that is accessible by the runtime (380). If a read-only basic block tries to write to is program storage area, an error condition occurs (525). If the block is not designated as read-only, then the basic block is permitted to issue the write instruction to the program storage area (530), and a counter is incremented (535). Preferably, the write to the protected program storage area is only permitted where the program is writing to protected memory that has been allocated to the CSECT to which the basic block belongs. The modification is made to the in-memory copy of the basic block, rather than to the copy of the basic block resident in cache (370), to ensure consistency of the cached copy. Next, an instruction modification flag is checked (540) to determine whether the code has previously been marked as reentrant code. In one embodiment, the flag is set to negative by default, such that a basic block retrieved from the cache (370) is presumed not to be reentrant. Alternatively, the default assumption may be that a program is reentrant. At step 540, the flag indicating that the program has modified itself rather than indicating reentrancy, may be checked. If at step (540) the flag has already been set, then the counter is compared to a threshold setting in step (545). Just-in-time compilation of programs that make too many modifications to themselves is inefficient. If the counter value is greater than or equal to a threshold setting, then a flag is set to direct the dispatcher to use the interpreter (550), rather than to continue to JIT-compile the basic block. If the count of writes to the program storage area is less than the threshold value, then JIT compilation will proceed. In one embodiment, at step (570), the execution of the previous instruction may be unrolled. In another embodiment, the execution of the basic block continues at step (570). Whether or not the last instruction is unrolled, the JIT-compiled basic block is deleted from memory, and the corresponding bits of the bitmap are cleared, if a bitmap is used. This allows the recompiled block to be loaded in memory, and bitmap settings reflecting the addresses of instructions present in the now recompiled block to be set, before execution of the basic block proceeds.

In one embodiment, after unrolling execution of the previous instruction at step (570), at step (575), the runtime checks whether the flag directing execution in the interpreter is set. In either case, at step (570), the previous execution of the basic block is unrolled. Specifically, this unrolling includes deleting JIT-compiled basic block from memory, and clearing the corresponding bits of the bitmap, if a bitmap is used. In some cases. If the flag is not set, then the dispatcher directs recompilation of the basic block and insertion of the recompiled block in the main memory of the runtime (580), where the modified block resides, rather than from the cache (370), which stores the unmodified version of the basic block. If the flag requiring execution of the basic block by the interpreter is set, then the dispatcher directs the execution flow for the basic block to the interpreter (590). The interpreter is able to proceed with execution of the next instruction because, at the time of the interrupt, state was saved. This lazy detection of the reentrant status of the basic block improves system performance where the common case is that programs are not reentrant. In the common case of programs that do not modify themselves, the lazy detection and setting of the instruction modification flag, system performance is improved because the runtime avoids executing unnecessary instructions to determine whether ordinary writes to memory are writes to program instructions, and also avoids the overhead of creating and maintaining data structures to track such writes.

In another embodiment, execution of the basic block continues at step (570), without unrolling the last instruction of the basic block. In this embodiment, the dispatcher directs recompilation of the basic block and insertion of the recompiled block in the main memory of the runtime (580), where the modified block resides, rather than from the cache (370). In this embodiment, the number of times that a basic block modifies itself may exceed the threshold, if the basic block further modifies its own code before it completes execution. However, after execution of the basic block has completed, the set flag has been will cause the dispatcher to direct execution of the basic block to the interpreter if it is invoked again by the CSECT.

In an alternative embodiment, the default state for a basic block could be to have a flag set to permit the execution of self-modifying code. In such a system, the attempt by the block to write to the program storage area would still cause a memory protection fault (505), but the flag would signify whether the basic block is permitted to modify itself, rather than whether the block has in fact modified itself. In this embodiment, the setting of the flag at step (560) is not required, but the flag must be cleared in step (550). A person of ordinary skill in the art would recognize that the program code could be implemented to test for an unset rather than a set condition, of to change flag settings if the count exceeded a threshold, rather than if the count were equal to a threshold. Alternatively, rather than setting a flag for use by the dispatcher, the exception handler could use a return code or other signal at step (590) to indicate to the dispatcher or the runtime environment to place the object in memory, but not in the cache.

In some applications, CSECTs may store program data, in addition to program instructions, in the program storage area. Such CSECT may be self-modifying in they write to such data, rather than to instructions, that are located within the program storage area. However, such operations would not generally warrant recompilation, and the associated cost of such recompilation. Because computer programs generally modify data with much higher frequency than their own instructions, the operation described above may result unnecessary recompilation, or in redirecting such programs to the interpreter (590), even though they make few, or even no modifications to their program code. By using table that identifies which addresses in the program's memory space correspond to instructions, one might distinguish between CSECTs writing to their own data, which does not require recompiling the code, and CSECTs writing to their own instructions. However, the creation of a table to map the entire memory space of the program, and checking this table for every write would introduce considerable overhead to the system. The use of a bitmap, rather than a table, to indicate the addresses of program instructions, may reduce overhead somewhat. But, creating such a bitmap for every program, and performing a check against the bitmap for every write by every program, negatively effects performance.

In some cases, a load module (310) may be marked with metadata prohibiting the code to be reentrant or indicating that the code is read-only code. The metadata may alternatively indicate whether the code is permitted to be self-modifying. The load module (310) may include one or more CSECTS, which may not be contiguous. Where CSECTS are discontiguous with each other, each CSECT has its own corresponding memory area. An individual C SECT may be marked with its own metadata. In one embodiment, the loader detects the circumstance in which a program should not permit modifications to its own code, and places the program in protected memory to prevent modification. If a program that has been placed in protected memory attempts to write to itself notwithstanding the restriction, the memory protection fault will cause the memory handler to interrupt execution and return an error.

By managed placement of compiled blocks in protected or unprotected memory, the lazy creation of a bitmap (or other data structure) indicating the addresses of compiled program instructions, and the lazy verification of writes to the program storage area against the bitmap, the problem of redirecting CSECTS that modify internal data can be resolved, while avoiding the overhead associated with requiring such verifications for every program write operation. FIG. 11 and FIG. 12 depict the operation of the handling of self-modifying code in accordance with an embodiment of the load module compiler, whereby a bitmap is generated when a block attempts to modify itself, and the bitmap indicates the legacy addresses corresponding to blocks compiled with the load module compiler and linked to the application.

In one embodiment, when a block that has been compiled by the load module compiler is linked and loaded, the loader is configured to designate the memory containing the block as protected memory by default. As illustrated in FIG. 11, if the program subsequently attempts to write to a protected block, a memory protection fault (1105) will be detected. The exception handler first checks to determine whether the write is to a program storage area (1110). Where the write is not to a program storage area, the exception handler proceeds as it would for to the default protection handler at step (1120). An example of a default protection handler for use with a load module compiler and legacy application environment is described in U.S. Pat. No. 9,979,034 titled Protection Key Management and Prefixing in Virtual Address Space Emulation System, which is incorporated herein by reference in its entirety. If the write is to a program storage area, then the exception handler checks to see whether the block has been designated read only (1130), and optionally checks to determine whether there has been a protection key violation (1145). The step of checking whether there has been a protection key violation (1145) may be bypassed or omitted as an optimization where a reduced number of protection keys is employed by the system. In the case of an attempted write to a read only block or a protection key violation, the exception handler generates an error condition (1140). When neither condition is met, the write is permissible, and the exception handler checks to determine whether a bitmap exists for the block at step (1150). A bitmap may have been created in response to an earlier write to a protected block. In one embodiment, a null pointer to the bitmap indicates that it has not yet been created for the load module, and at (1160), a bitmap is created and populated such that the bits of the bitmap indicate the addresses of program instructions compiled by the load module compiler for the load module (1160). After the bitmap is populated, or if the bitmap already exists, the handler unprotects the memory block (1170) and allows the write to the instruction (1180). The size of block that is protected and unprotected may be constrained by the minimum block size handled by the memory protection fault handler. In one embodiment, this minimum block size is 4 kB. Other block sizes may be used. In one embodiment, the multiple blocks corresponding the compiled basic blocks, are unprotected. The modification is made to the in-memory copy of the basic block, rather than to the copy of the basic block resident in cache (370), to ensure consistency of the cached copy. In one embodiment, the bitmap described above is a bit array in which each bit of the array indicates two bytes of memory. Since legacy program instructions of a load module typically occupy two to six bytes, a write to a program's own instruction area will affect memory locations corresponding to one to three bits of the bitmap. A courser grained bitmap, with each bit indicating a larger size block of memory, could be used to reduce the size of the bitmap, where the program instruction size is larger. Other data structures, such as a table, or a hierarchical data structure that divides program storage using a binary tree or b-tree with nodes indicating specific addresses, or sets of addresses that have been modified may be employed instead of the bitmap. In one embodiment, the step of allowing write to instruction (1180) will switch the memory write routine used by the runtime to include a for the existence of the bitmap, and return the control flow to the runtime to retry the write operation. Since most programs are not self-modifying, altering the memory write routine only in the event of a self-modifying program avoids adding overhead of checking for the bitmap on every system write. Alternatively, the default memory write routine may perform the initial check for the existence of a bitmap, as discussed below.

An advantage of the approach depicted in FIG. 11 over a system that checks a bitmap for every program write is improved performance of a load module compiler that supports self-modifying programs. For example, such a system reduces the overhead associated with unnecessarily verifying writes against a bitmap. By deferring the creation of the bitmap until a load module executing with the load module described herein attempts to write to its program storage area, the performance of the system when executing load modules that do not modify themselves is increased by reducing the number of instructions executed in program writes. The overhead associated with creating and managing the bitmaps is also avoided for programs that do not write to their program storage area. In addition, where a load module is capable of modifying itself, but only does do under conditions that infrequently arise at runtime, the execution of such load modules benefits from the reduced overhead. Changing the memory write routine to one that checks for the existence of a bitmap after a first modification has occurred, and otherwise using a default memory write routine that does not check for the existence of the bitmap at all, can further improve performance.

As seen in FIG. 12, when a memory write is performed (1200), the runtime checks to see whether a bitmap has been created for the currently executing load module (1205). If no bitmap exists, then the program continues execution (1210). In one embodiment a pointer to the bitmap is used as a flag, with a NULL or zero value indicating that the bitmap does not exist. Other flags may be used. By proceeding with normal operations without performing a lookup in the bitmap, the system reduces the overhead associated with checking the write against the contents of the bitmap for load modules that have not modified their code. If a bitmap has been created for the load module, the runtime checks whether a bit corresponding to the memory address being written has been set at step (1215). In one embodiment, the bitmap uses one bit for each two-byte portion of the address space of the load module. If the corresponding bit has not been set, then the program continues execution (1220). As discussed with respect to FIG. 4B and FIG. 11, the bits of the bitmap are set to indicate the addresses of instructions corresponding to basic blocks that have been compiled by the load module compiler. Where the load module includes data in blocks containing code, the use of the bitmap ensures that writes to data areas within the data blocks are distinguished from writes to program code. If the corresponding bit has been set, then the write was a write to an instruction that had been compiled by the load module compiler. A counter associated with the basic block is incremented (1225), to keep track of the number of times that the compiled basic block has modified program code. An additional flag indicating that the program is self-modifying may optionally be set at this time. Next, the counter is compared to a threshold setting (1230). If the count exceeds the threshold, then a flag is set (1235) to direct the dispatcher to use the interpreter. After the flag is set, or if the count is less than the threshold setting, the JIT-compiled basic block is deleted from memory, the corresponding bits of the bitmap are cleared, and the runtime continues execution of the basic block (1240).

In one embodiment, the compiled basic block is allowed to run to completion, whether or not the flag is set. In this embodiment, after step (1240), the basic block is recompiled and inserted in the main memory of the runtime (1255), rather than in the cache (370). In this embodiment, the number of times that a basic block modifies itself may exceed the threshold, if the basic block further modifies its own code before it completes execution. However, after execution of the basic block has completed, the set flag has been will cause the dispatcher to direct execution of the basic block to the interpreter if it is invoked again by the CSECT. Alternatively, after step (1240), the runtime may check the setting of the flag at step (1245). In this alternative embodiment, if the flag has been set, then execution is dispatched to the interpreter (1250). The interpreter is able to resume execution of the basic block because state was saved when the memory exception occurred. If at step (1245), the flag is not set, then the modified basic block is recompiled and inserted in RAM, rather than in the cache, the bitmap is updated to include settings for the recompiled basic block, and execution continues using the compiled basic block.

An advantage of the arrangement depicted in FIG. 12 is that verification of the bitmap settings upon a successful memory write reduces the overhead of write operations for programs that are not self-modifying. In addition, this sequencing takes the verification of the bitmap outside the critical path of write operations. In embodiments that defer a change to the memory write routine until after a program has modified its program storage area and a bitmap has been created, the verification at step 1205, and, in the event that a bitmap exists, the branch to a routine implementing step 1215, may be added to the memory write routine. In this way, when programs that do not modify their own program storage area execute, every memory write is not burdened with the added overhead of checking for the existence of the bitmap. In an alternate embodiment, the test for the bitmap may be included in the default memory write routine. To avoid the complications of involving invoking another routine to perform the steps described with respect to FIG. 12, or to avoid allowing the runtime to modify its own write routine, the steps of FIG. 12 could alternatively be included in the default memory write routine.

In another embodiment, the memory locations containing the code compiled by the load module compiler are not stored in protected memory, and the determination as to whether or not a program write was to a program storage area is carried out, not by the memory protection fault handler, but instead by the write function implemented in the runtime library (315). In this embodiment, a bitmap to indicate the addresses of JIT-compiled blocks is always used by the load module compiler, and every program write checks against the bitmap to determine whether or not there has been a write to a compiled basic block. This approach increases the overhead, because the bitmap is created even for programs that do not attempt to write to a program storage area, and because the bitmap must be checked for every program write. Although the overhead is higher using this approach will generally be higher, with a corresponding decrease in system performance, it may be desirable to implement in this fashion where modifying the memory protection handler is not desired, or is not possible.

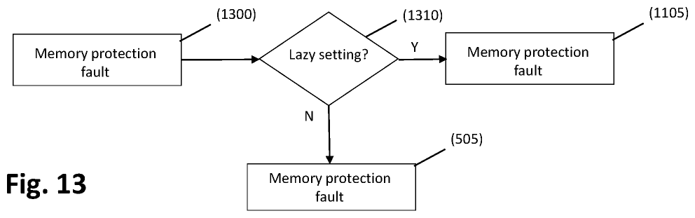

In some situations, it may be desirable to make the determination of whether to apply the approach that relies on the approach depicted in FIG. 5, or that in FIG. 11 and FIG. 12, at runtime. As seen in FIG. 13, in one embodiment, when a memory protection fault arises at step (1300), the handler may examine a flag or other setting (1310) indicating whether to apply the lazy approach, in which case it proceeds to step (1105) as described further with respect to FIG. 11, or not to apply the lazy approach, in which case it proceeds to step (505), as described further with respect to FIG. 5.

It is possible that the instructions of a self-modifying program might modify instructions that are part of the CSECT, but have not previously been executed. If the write instruction is to a basic block that has not previously executed in this instance, but that has previously been compiled by the load module compiler, the mechanism described above with respect to FIG. 11 and FIG. 12 will function where, as described above, the previously compiled basic blocks were linked when the current instance of the CSECT was started. Where the modification is to a program instruction that is not part of a basic block that was previously compiled by the load module compiler, the attempted write to the legacy program instruction will be recognized because the legacy code of the load module resides in protected storage. To handle self-modifying programs that modify such code, either the exception handler, the memory write routine, or a separate handler written to address such forward modifications to the code may be used, and a flag indicating that such code was modified may be set, so that when the load module compiler reaches the uncompiled block whose code has been modified, it will know to store the modified block in RAM, rather than in the cache. A data structure indicating that such modifications of code yet to be executed, or indicating the addresses of the legacy program that have been modified may be used. The data structure may also incorporate the bitmap of modifications to compiled code. The load module compiler can use the data structure to identify that a basic block that is selected for decompilation by the decompiler (320) and for subsequent compilation by the load module compiler (340) contains addresses that have been modified. Because the legacy load module may contain both compiled computer instructions and data, it may not be known until runtime whether the modified address contained a program instruction or data. However, where an instruction has been modified, the compiled basic block will not be added to the cache, as indicated by decision block (485), and will instead be placed in RAM and linked to the legacy program.

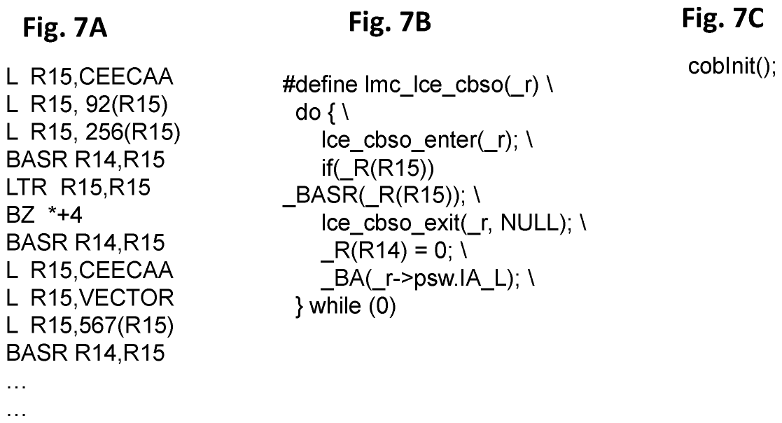

FIG. 7A illustrates an example of legacy code found at the beginning of a COBOL load module (310). To facilitate understanding, 7A is depicted using illustrative legacy assembly instructions, whereas the actual code of the load module would be in binary form. As described above, the load module decompiler (320) begins processing the load module by examining CSECT metadata that identifies the load module as having been compiled by a legacy COBOL compiler. Having determined that the load module was compiled using a COBOL compiler, the load module decompiler (320) recognizes that the first four instructions operate to initialize the load module.

The first instruction loads a structure, CEECAA, that describes the language environment. The second instruction loads a vector that indicates functions. In this case, the number 92 indicates and offset of 92 into the table identified by the previous table. The next instruction loads the address of the function, which is at an offset of 256 in the table loaded in the previous instruction. Finally, the fourth instruction stores a return address at R14, and then branches to the address returned by the function at the 256 offset. The fifth through seventh instructions of FIG. 7A optionally invoke another function. The eighth through eleventh instructions illustratively show the invocation of an exit routine.

Absent optimization by the load module decompiler (320), these instructions would be translated into the LLVM-IR representation. An earlier load module compiler would have translated the instructions into C program instructions, as shown in FIG. 7B. However, in accordance with one embodiment of the inventive system, the load module decompiler (320) determines, based on metadata associated with the load module, that a legacy COBOL compiler was used to generate the load module, and thus recognizes the invocation of the enter, exit, and optional functions of FIG. 7A as the invocation of a COBOL initialization sequence, and replaces the entire sequence with a call to an optimized external library, cobInit( ), as depicted in FIG. 7C. The insertion of this external library call into the intermediate code (330), by the load module decompiler (330), enables the load module compiler (340), to include and link the external runtime library function by retrieving it for from runtime library (360).

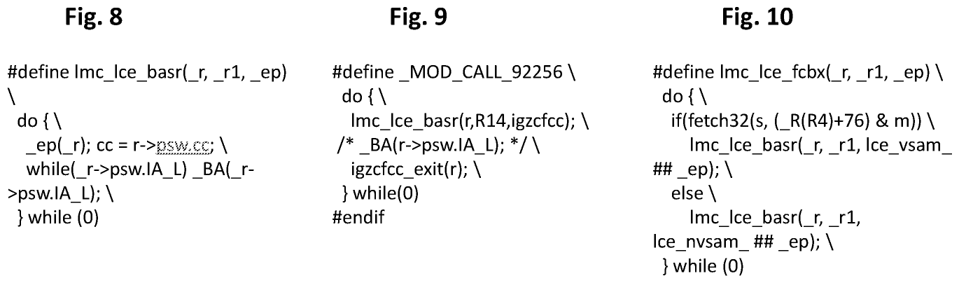

Similar to FIGS. 7B, 8, 9, and 10 illustrate using C language instructions corresponding to patterns that can be recognized by the load module decompiler (320), and replaced with optimized calls to the respective function types. In one embodiment, legacy SYSTEM/390® (IBM, New York) or SYSTEM/Z® (IBM, New York) machine instructions and system calls are present in the load modules (310), and where the decompiler does not specifically substitute an optimized external function into the code, it inserts inline functions in LLVM-IR code format. Other intermediate language representations may be used. In FIG. 8, a call to a generic library call is represented. In FIG. 9, a call to a native API that replaced a legacy function is represented. In FIG. 10, a call to an input/output routine that has similarly been replaced by a native routine is represented. By configuring the load module decompiler (320) to recognize the pattern used to invoke these functions and libraries, the load module decompiler (320) may directly replace corresponding sets of instructions with corresponding library functions from legacy function library (315), or, where such functions are unavailable, references to optimized runtime library functions found in runtime library (360). These optimizing substitutions of the load module decompiler (320) improve the performance of the decompiler, and enable the load module compiler (340) to perform additional optimizations on basic blocks containing the corresponding library functions or external references. In one embodiment, SVC instructions have corresponding optimized LLVM-IR code stored in legacy function library (315), and the load module decompiler makes the corresponding substitutions. Because some SVC functions invoke runtime library functions, the insertion of an SVC function from legacy function library (315) into the intermediate code (330) by the load module decompiler (320) may also result in the insertion of a call to a runtime library function call. The load module compiler (340) may then insert the corresponding runtime function after retrieving it from runtime library (360). In another example, a unicode conversion instruction may be replaced by a call to a corresponding runtime library function.

An article of manufacture such as a disk, tape, flash drive, optical disk, CD-ROM, DVD, EPROM, EEPROM, optical card or other type of processor-readable storage medium may be used for storing electronic instructions. Computer instructions may be downloaded from a computer such as a server, to a requesting client computer or handheld device, using a communications link or network connection.

A system for storing and/or executing program instructions typically includes at least one processor coupled to memory through a system bus or other data channel or arrangement of switches, buffers, networks, and channels. The memory may include, cache memory, local memory employed during execution of the program. Computers that run such instructions may be standalone computers or networked computers, in a variety of different form factors such as servers, blade servers, laptops or desktop computers, mobile devices such as tablet or other multi-function handheld computing devices. Though the disclosed herein used Intel x86 or ARM processors, other processors may be used without effect on the invention disclosed herein. Main memory can be Random Access Memory (RAM), or other dynamic storage devices known in the art. Read only memory can be ROM, PROM, EPROM, Flash/EEPROM, or other known memory technologies. Mass storage can be used to store data or program instructions. Examples of mass storage include disks, arrays of disks, tape, solid state drives, and may be configured in direct attached, networked attached, storage area network, or other storage configurations that are known in the art. Removable storage media include tapes, hard drives, floppy disks, zip drives, flash memory and flash memory drives, optical disks and the like. Computer program instructions for performing operations of the systems described herein may be stored in one or more than one non-transitory storage medium, including of the various different types of non-transitory storage media discussed herein.

The embodiments described above described input/output between the host and appliance devices, and examples including input/output between the legacy and appliance processors and DASD, local disks, and main memory. Other examples of input/output devices which may be applicable to embodiments of the invention described herein include additional I/O devices (including, but not limited to, keyboards, pointing devices, light pens, voice recognition devices, speakers, displays, printers, plotters, scanners, graphic tablets, disk drives, solid state drives, tape drives, CD-ROM drives, DVD drives, thumb drives and other memory media, etc.) can be coupled to the system either directly or through intervening I/O controllers. Network adapters may also be coupled to the system to enable the data processing system to be coupled to other data processing systems or remote printers or to storage devices through private or public networks.

Some embodiments described above describe the setting of flags in response to various conditions, such as the setting of a flag to direct the use of the interpreter for a basic block. As used herein, references to setting a flag shall be understood to include not only writing a specified value to the flag, but also to include not changing the value of the flag, where the existing value already indicates the desired setting. For example, if the default state of a flag were null or zero, a person of ordinary skill in the art would understand setting the flag to the null or zero state includes leaving the state of the flag unchanged from its default setting. Similarly, a person of ordinary skill in the art would understand that defining a flag to have one meaning when set, and another meaning when unset is equivalent to defining the flag to have the first meaning when unset and the second meaning when set, and using the corresponding opposite settings to evaluate a condition.

Many examples are provided herein. These examples may be modified without departing from the spirit of the present invention. The examples and embodiments described herein are only offered as examples, and other components, modules, or products may also be used. For example, additional architectures may be used and other types of machine instructions or operating system calls may be used. Additionally, although certain specific message types and databases are described herein, any suitable message type may be used. There are many other variations that can be included in the description described herein and all of these variations are considered a part of the invention.

1. A method for constructing a library of transformation functions for translating a legacy executable program from a source architecture to a target architecture different from the source architecture, the method comprising:
providing a first library of transformation functions that each transform a statement in the legacy executable program into a representation in an intermediate representation;
receiving a load module;
obtaining an original legacy instruction or legacy system call from the load module in a first system architecture;
obtaining a function from said legacy function library, the function being in an intermediate representation of code for implementing a legacy function;
inserting said function obtained from said legacy function library for said original legacy instruction or legacy system call into an intermediate representation of a basic block;
inserting labels corresponding to said function obtained from said legacy function library into an index associated with said basic block; and
storing said intermediate representation of said basic block and said index into a second library of transformation functions, wherein each transformation function of said second library represents a basic block encoded in an intermediate representation.

2. The method of claim 1, further comprising parsing a sequence of instructions or function calls of said load module by a parser.

3. The method of claim 2, wherein said parsing comprises identifying each instruction or function call in a basic block of said load module.

4. The method of claim 3, wherein said basic block comprises a sequence of instructions beginning with an entry point and continuing to a branch instruction.

5. The method of claim 3, wherein said basic block comprises a sequence of instructions beginning with an entry point and continuing to a branch instruction that branches to an address not already identified within the basic block.

6. The method of claim 3, wherein said basic block comprises a sequence of instructions beginning with an entry point, and continuing to the earlier of a branch instruction, or until a predefined threshold number of instructions is included in the basic block.

7. The method of claim 3, wherein the instructions of said basic block comprise a sequence of instructions beginning with an entry point, and continuing until a state saving operation is detected within a CSECT of the legacy executable program.

8. A non-transitory computer readable medium configured to store instructions, the instructions when executed by one or more processors to cause the one or more processors to execute the legacy executable program compiled for the source architecture on a machine having the target architecture by performing steps according to the method of claim 1.

9-10. (canceled)

11. A method of generating a library of intermediate representations of basic blocks of a first program, said first program compiled for a source architecture having an instruction set that differs from an instruction set of a target architecture different from the source architecture, for use by a load module compiler, the method comprising:
providing a library of legacy functions that each transform one or more instructions of the instruction set for said source architecture into an intermediate representation;
generating by a decompiler, an indicator of a compiler type used to compile said first program according to said source architecture using metadata associated with said first program;
based on said indicator, identifying by the decompiler, a set of instructions to initialize the first program;
replacing said set of instructions to initialize the first program with an intermediate representation of an initialization routine;
parsing said first program by said decompiler, to identify sequences of instructions and system calls corresponding to a basic block of said first program;
replacing said sequences of instructions and system calls in said basic block by in-lining functions from said library of legacy functions into an object corresponding to said basic block to create an intermediate representation of said basic block; and
storing the intermediate representation of said basic block in the library of intermediate representations of basic blocks of the first program.

12. (canceled)

13. A non-transitory computer readable medium configured to store instructions, the instructions when executed by one or more processors to cause the one or more processors to generate the library of intermediate representations of basic blocks of the first program according to the method of claim 11.

14-18. (canceled)

19. A method of executing a first program compiled for a source architecture on a processor having a target architecture different from the source architecture, the method comprising:
providing a library of legacy functions that each transform one or more instructions of said source architecture into an intermediate representation;
parsing said first program to identify a sequence of instructions of said source architecture comprising a basic block;
replacing the instructions with functions of said library, to generate an intermediate representation of said basic block;
storing the intermediate representation of said basic block in a store;
compiling by a back-end compiler, said intermediate representation of said basic block, into a representation of said basic block in said target architecture;
storing said compiled representation of said basic block in a cache indexed by processor type;
retrieving said compiled representation of said basic block from said cache; and
linking said basic block in a runtime environment, said runtime environment configured for execution of instructions in accordance with said target architecture; or
the method comprising:
providing a cache of compiled basic blocks, wherein each said compiled basic block is a representation of the basic block of said first program, translated from said source architecture into said target architecture;
determining whether a next basic block for the execution of said program by the runtime environment having said target architecture is present in said cache, and whether said cached basic block includes a label required for execution by said runtime;
upon determining that said label is present in said next basic block, linking said basic block in the runtime environment and executing the basic block;
upon determining that said next basic block is not present in said cache, or that said next basic block is missing said label, initiating a process by a decompiler to identify the next basic block in said first program, and to translate said basic block into an intermediate representation;
compiling the intermediate representation of said basic block into an executable for said target architecture, and
storing said compiled basic block in said cache; or
the method comprising:
providing a library of legacy functions in an intermediate representation, wherein the legacy functions implement one or more instructions, language functions, or runtime functions of said source architecture;
selecting by a decompiler, a sequence of instructions of said first program compiled for said source architecture, wherein the sequence comprises the basic block;
identifying sets of one or more instructions in said basic block that correspond to one or more functions of said library of legacy functions;
replacing the identified sets of one or more instructions with their corresponding library functions to generate an intermediate representation of said basic block;
storing the intermediate representation of said basic block in a store;
compiling by a back-end compiler, said intermediate representation of said basic block, into a representation of said basic block compiled for said target architecture;
storing said compiled representation of said basic block in the cache;
retrieving said compiled representation of said basic block from said cache; and
linking said compiled representation of the basic block to the first program while the first program is executing in the runtime environment, wherein the runtime environment is configured to execute of instructions of the first program compiled for the source architecture on a processor of the target architecture.

20. The method of claim 19, wherein said legacy functions of said library of legacy functions comprise functions of an interpreter, compiled into an intermediate representation, or one or more initialization functions.

21-23. (canceled)

24. The method of claim 19, further comprising using an indicator of the compiler type used to compile the first program into executable form according to said source architecture, to enable optimization by a decompiler, wherein said decompiler:
replaces a plurality of instructions of said next basic block in accordance with said source architecture, with an intermediate representation of an initialization routine in said intermediate representation of said basic block, based upon said indicator; or
replaces a plurality of instructions of said next basic block in accordance with said source architecture, with an intermediate representation of an input-output routine in said intermediate representation of said basic block, based upon said indicator.

25-26. (canceled)

27. The method of claim 19, further comprising compiling by a second back-end compiler, said intermediate representation of said basic block, into a second representation of said basic block said target architecture, and storing said compiled basic block in said cache, with an index entry indicating the processor type associated with said second back-end compiler.

28-33. (canceled)

34. A non-transitory computer readable medium configured to store instructions, the instructions when executed by one or more processors to cause the one or more processors to execute the first program according to the method of claim 19.

35-83. (canceled)

84. A method of executing a first program compiled for a source architecture on a system with one or more processors having a target architecture different from the source architecture, the method comprising:
initiating execution of the first program in a runtime environment configured to support the execution of programs compiled for execution in the source architecture, said runtime environment operating on one or more of said processors having said target architecture;
after the first program has started execution, linking to the first program a basic block compiled by a load module compiler;
detecting an attempt by a write instruction of said basic block to write to a memory location in a memory block containing a compiled instruction of said first program;
determining whether a data structure that stores indications of the addresses of instructions compiled by the load module compiler and linked to the first program exists;
upon determining that the data structure does not exist, creating the data structure and populating it with indications of the locations of the instructions compiled by the load module compiler and linked to the first program;
allowing execution of the write instruction to modify contents of said memory block containing a compiled instruction of said first program;
determining, based on the contents of the data structure, whether the write instruction modified a program instruction of said first program; and
upon determining that the write instruction modified said instruction of said first program, incrementing a counter associated with the basic block whose instruction was modified, or upon determining that the write instruction did not modify said instruction of said first program, continuing execution of the first program; or
the method comprising:
initiating execution of the first program in the runtime environment configured to support the execution of programs compiled for execution in the source architecture, said runtime environment operating on one or more of said processors having said target architecture;
after the first program has started execution, linking to the first program the basic block compiled by the load module compiler;
detecting an attempt by an instruction of said basic block to write to the memory location in the memory block containing the compiled instruction of said first program;
determining whether the data structure that stores indications of the addresses of instructions compiled by the load module compiler and linked to the first program exists;
upon determining that the data structure does not exist, creating the data structure and populating it with indications of the locations of the instructions compiled by the load module compiler and linked to the first program;
allowing execution of the write instruction to modify contents of said memory block containing the compiled instruction of said first program;
based in-part on the contents of the data structure, determining whether the write instruction modified the compiled program instruction of said first program that does not have the corresponding basic block in the cache; and
upon determining that the write instruction modified the instruction of said first program that does not have a corresponding basic block in the cache, storing an indication that the first program is self-modifying and an indication of the memory location that has been modified.

85. The method of claim 84, wherein said detecting an attempt to write to a memory location in a memory block containing a compiled program instruction comprises detecting an attempt to write to protected storage and unprotecting said memory block containing a compiled program instruction.

86-88. (canceled)

89. The method of claim 84, further comprising recompiling by the load module compiler, the basic block whose program instruction was modified.

90-91. (canceled)

92. A non-transitory computer readable medium configured to store instructions, the instructions, when executed by one or more processors to cause the one or more processors to execute the first program compiled for the source architecture on the system with one or more processors having the target architecture different from the source architecture by performing the method according to claim 84.

93-105. (canceled)

106. The method of claim 19, wherein the decompiler determines the extent of said sequence comprising a basic block, based in part on:
detecting a repeated sequence of instructions whose index variable changes;
detecting a repeated sequence of instructions whose index variable changes, followed by a loop; or
detecting a repeated sequence of instructions whose index variable changes is a partially unrolled loop.

107-129. (canceled)
